(19) United States
(12) Patent Application Publication
(10) Pub. No.: US 2026/0273926 A1
(43) Pub. Date: Sep. 17, 2026

(54) LIQUID EJECTING HEAD AND LIQUID EJECTING APPARATUS

(71) Applicant: SEIKO EPSON CORPORATION, Tokyo (JP)

(72) Inventors: Kei YAMAGUCHI, SHIOJIRI-SHI (JP); Hiroyuki ISHII, SHIOJIRI-SHI (JP)

(21) Appl. No.: 19/567,696

(22) Filed: Mar. 16, 2026

(30) Foreign Application Priority Data
Mar. 17, 2025 (JP) 2025-042142

(51) Int. Cl. B41J 2/045; B41J 2/14

(52) U.S. Cl. CPC B41J 2/0451; B41J 2/04581; B41J 2/14233; B41J 2002/14491

(57) ABSTRACT

A liquid ejecting head includes: a piezoelectric substrate having a plurality of piezoelectric elements for ejecting a liquid; a wiring substrate; and a flexible substrate provided with a plurality of wirings and electrically coupling the piezoelectric substrate and the wiring substrate, in which the plurality of wirings include a plurality of drive signal wirings respectively coupled to the plurality of piezoelectric elements, and a first dummy wiring and a second dummy wiring that are adjacent to each other for detecting deterioration of the flexible substrate caused by migration and are held at different potentials.

The present application is based on, and claims priority from JP Application Serial Number 2025-042142, filed Mar. 17, 2025, the disclosure of which is hereby incorporated by reference herein in its entirety.

### BACKGROUND

### 1. Technical Field

The present disclosure relates to a liquid ejecting head and a liquid ejecting apparatus.

### 2. Related Art

Liquid ejecting apparatuses are known that print images by ejecting a liquid such as ink from a plurality of nozzles using piezoelectric elements. For example, a liquid ejecting apparatus has a liquid ejecting head including a plurality of drive elements for ejecting a liquid. For example, JP-A-2016-88084 discloses a liquid ejecting head provided with a flexible cable having a plurality of individual coupling wirings and a common coupling wiring for driving a plurality of piezoelectric elements. Hereinafter, the flexible cable may also be referred to as a flexible substrate.

A flexible substrate is provided with a plurality of wirings to which different potentials are applied. Furthermore, the interval between the wirings of the flexible substrate is narrow. When moisture adheres to such a flexible substrate or when the flexible substrate is exposed to a high humidity environment, a phenomenon occurs in which a metal contained in the wiring on the flexible substrate is ionized and moves. The phenomenon is called ion migration or electrochemical migration. Hereinafter, ion migration, that is, electrochemical migration, will also be simply referred to as migration. When migration occurs, there is a concern that individual coupling wirings or individual coupling wirings and common coupling wirings may be coupled to each other, causing a short circuit. Therefore, it is desirable to predict the life of a flexible substrate caused by migration before an ejection failure occurs due to migration.

### SUMMARY

According to an aspect of the present disclosure, there is provided a liquid ejecting head including: an actuator substrate having a plurality of drive elements for ejecting a liquid; a wiring substrate; and a flexible substrate provided with a plurality of wirings and electrically coupling the actuator substrate and the wiring substrate, in which the plurality of wirings include a plurality of individual signal wirings respectively coupled to the plurality of drive elements, and a first wiring and a second wiring that are adjacent to each other for detecting deterioration of the flexible substrate caused by migration and are held at different potentials.

According to another aspect of the present disclosure, there is provided a liquid ejecting apparatus including: the above-described liquid ejecting head; and a detection circuit that outputs a detection signal for detecting a short circuit between the first wiring and the second wiring.

### BRIEF DESCRIPTION OF THE DRAWINGS

FIG. 1 is a schematic diagram illustrating a configuration of a liquid ejecting apparatus according to a first embodiment.

FIG. 2 is a diagram showing a functional configuration of the liquid ejecting apparatus shown in FIG. 1.

FIG. 3 is an exploded perspective view of a liquid ejecting head shown in FIG. 2.

FIG. 4 is an explanatory view for describing a schematic structure of a liquid ejecting module shown in FIG. 3.

FIG. 5 is a cross-sectional view showing a piezoelectric substrate of FIG. 4.

FIG. 6 is a plan view showing the piezoelectric substrate of FIG. 4.

FIG. 7 is a view showing a flexible substrate shown in FIG. 4.

FIG. 8 is a view showing another example of the flexible substrate.

FIG. 9 is a view showing a flexible substrate according to a first modification example.

FIG. 10 is a view showing a flexible substrate according to a second modification example.

FIG. 11 is a view showing a flexible substrate according to a third modification example.

### DESCRIPTION OF EMBODIMENTS

Embodiments for carrying out the present disclosure will be described below with reference to the drawings. Meanwhile, in each drawing, the dimensions and scale of each portion are different from the actual dimensions and scale as appropriate. In addition, the embodiments described below are preferred specific examples of the present disclosure, and therefore, various technically preferable limitations are given, but the scope of the present disclosure is not limited to these forms unless there is a description to the effect that the present disclosure is particularly limited in the following description.

### 1. First Embodiment

### 1-1. Overall Configuration of Liquid Ejecting Apparatus 100

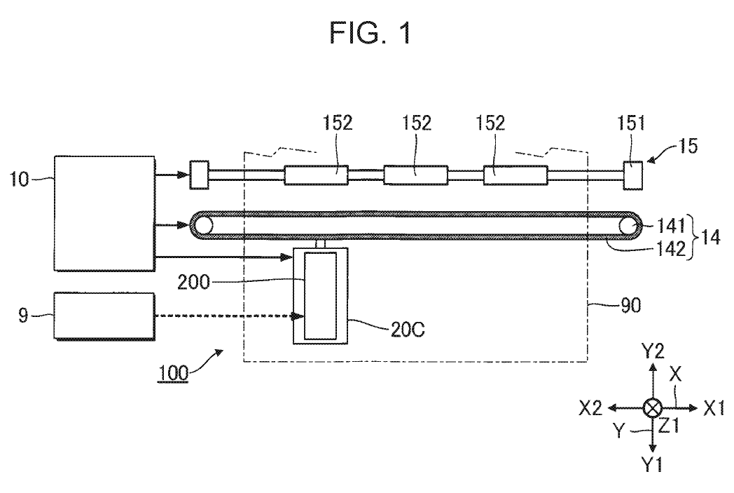

FIG. 1 is a schematic diagram illustrating a configuration of a liquid ejecting apparatus 100 according to a first embodiment. For convenience of description, the following description will be made using an X-axis, a Y-axis, and a Z-axis, which are orthogonal to each other as appropriate. In the following description, one direction along the X-axis is referred to as an X1 direction, and the direction opposite to the X1 direction is referred to as an X2 direction. Similarly, one direction along the Y-axis is referred to as a Y1 direction, and the direction opposite to the Y1 direction is referred to as a Y2 direction. One direction along the Z-axis is referred to as a Z1 direction, and the direction opposite to the Z1 direction is referred to as a Z2 direction. Also, viewing in a direction along the Z-axis may be referred to as “in a plan view”. The Z-axis is typically a vertical axis. The Z2 direction is an upward direction, and the Z1 direction is a downward direction. Hereinafter, a +Z direction may be referred to as the upward or upward direction, and a −Z direction may be referred to as the downward or downward direction. Note that, the Z-axis may not be the vertical axis. The X-axis, the Y-axis, and the Z-axis are typically orthogonal to each other, but are not limited thereto, and only need to intersect each other at, for example, an angle within a range of, for example, 80° or more and 100° or less.

The liquid ejecting apparatus 100 in FIG. 1 is an ink jet printing apparatus that ejects a liquid such as ink onto a medium 90. As shown in FIG. 1, in the present embodiment, it is assumed as an example that the liquid ejecting apparatus 100 is a so-called serial printer. The medium 90 is typically printing paper, but any printing target made of a resin film, fabric, or other material is used as the medium 90. A liquid container 9 for storing a liquid is installed on the liquid ejecting apparatus 100. For example, a cartridge that can be attached to and detached from the liquid ejecting apparatus 100, a bag-shaped liquid pack made of a flexible film, or a liquid tank that can be replenished with a liquid is used as the liquid container 9.

The liquid ejecting apparatus 100 includes a control unit 10, a medium transport mechanism 15, a moving mechanism 14, and a liquid ejecting head 200.

The control unit 10 includes, for example, one or more processing circuits such as a central processing unit (CPU) or a field programmable gate array (FPGA) and one or more storage circuits such as a semiconductor memory, and comprehensively controls each element of the liquid ejecting apparatus 100.

The medium transport mechanism 15 transports the medium 90 in a direction along the Y-axis under the control of the control unit 10. For example, the medium transport mechanism 15 includes a transport motor 151 and a plurality of transport rollers 152. The transport motor 151 operates under the control of the control unit 10. The plurality of transport rollers 152 rotate in accordance with an operation of the transport motor 151. As the plurality of transport rollers 152 rotate, the medium 90 is transported in a direction along the Y-axis, which is a transport direction.

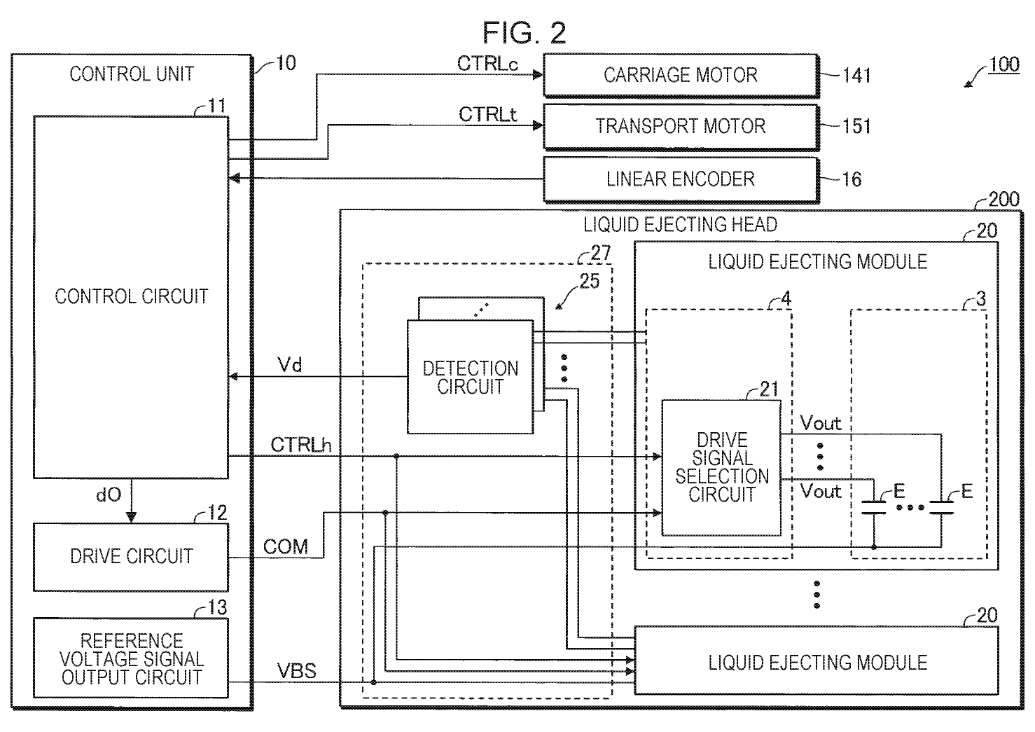

The moving mechanism 14 reciprocates a carriage 20C on which the liquid ejecting head 200 is mounted along the X-axis under the control of the control unit 10. For example, the moving mechanism 14 includes a carriage motor 141 and an endless belt 142. The carriage motor 141 operates under the control of the control unit 10. The endless belt 142 rotates in accordance with an operation of the carriage motor 141. This causes the carriage 20C fixed to the endless belt 142 to reciprocate along the X-axis, which is a scanning axis. Also, a linear encoder 16 shown in FIG. 2, which will be described later, is attached to the moving mechanism 14 in order to output a position detection signal based on the position of the carriage 20C.

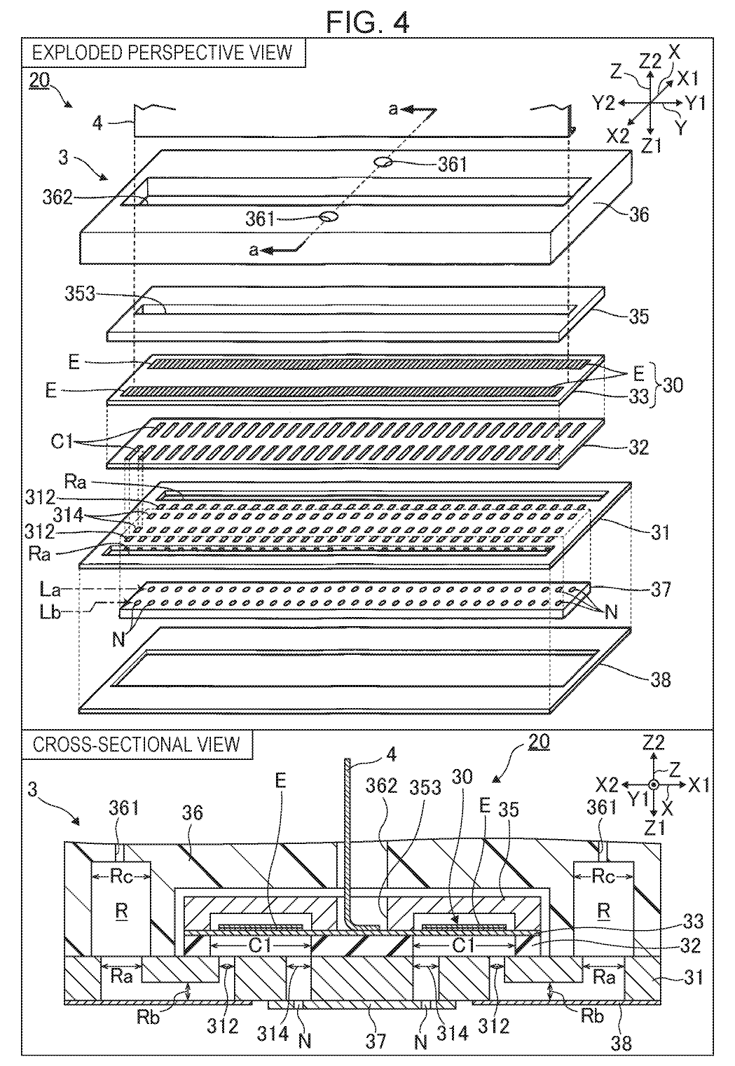

The liquid ejecting head 200 ejects the liquid supplied from the liquid container 9 onto the medium 90 from a plurality of nozzles N shown in FIG. 4, which will be described later, under the control of the control unit 10. An image is formed at the surface of the medium 90 by each liquid ejecting head 200 ejecting a liquid onto the medium 90 in parallel with the transport of the medium 90 by the medium transport mechanism 15 and the reciprocating movement of the carriage 20C by the moving mechanism 14.

In FIG. 1, it is assumed that the liquid ejecting apparatus 100 is a serial printer, and therefore a serial head method in which the liquid ejecting head 200 reciprocates above the medium 90 is employed as the printing method. However, the printing method of the liquid ejecting apparatus 100 may be a line head method in which the liquid ejecting head 200 is fixed. That is, the liquid ejecting apparatus 100 may be a so-called line printer.

FIG. 2 is a diagram showing the functional configuration of the liquid ejecting apparatus 100 shown in FIG. 1.

The control unit 10 includes a control circuit 11, a drive circuit 12, and a reference voltage signal output circuit 13. The control circuit 11 receives an image information signal including image data or the like from an external device such as a host computer that is coupled to the outside of the liquid ejecting apparatus 100 in a communicable manner. The control circuit 11 generates various signals for controlling the liquid ejecting apparatus 100 based on the image information signal, and outputs the various signals to the corresponding components.

In addition to the image information signal, the control circuit 11 receives a position detection signal from the linear encoder 16 based on a scanning position of the carriage 20C. The control circuit 11 ascertains the scanning position of the liquid ejecting head 200 mounted on the carriage 20C based on the position detection signal. The control circuit 11 generates a control signal CTRLc for controlling the movement of the liquid ejecting head 200 in accordance with the scanning position of the liquid ejecting head 200, and outputs the generated control signal CTRLc to the carriage motor 141. The control circuit 11 also generates a control signal CTRLt for controlling the transport of the medium 90, and outputs the generated control signal CTRLt to the transport motor 151.

The control circuit 11 generates a control signal CTRLh for controlling the liquid ejecting head 200 based on the above-described image information signal and the scanning position of the liquid ejecting head 200, and outputs the generated control signal CTRLh. The control signal CTRLh includes, for example, a print signal, a latch signal, a clock signal, and the like for designating the type of operation of the liquid ejecting head 200.

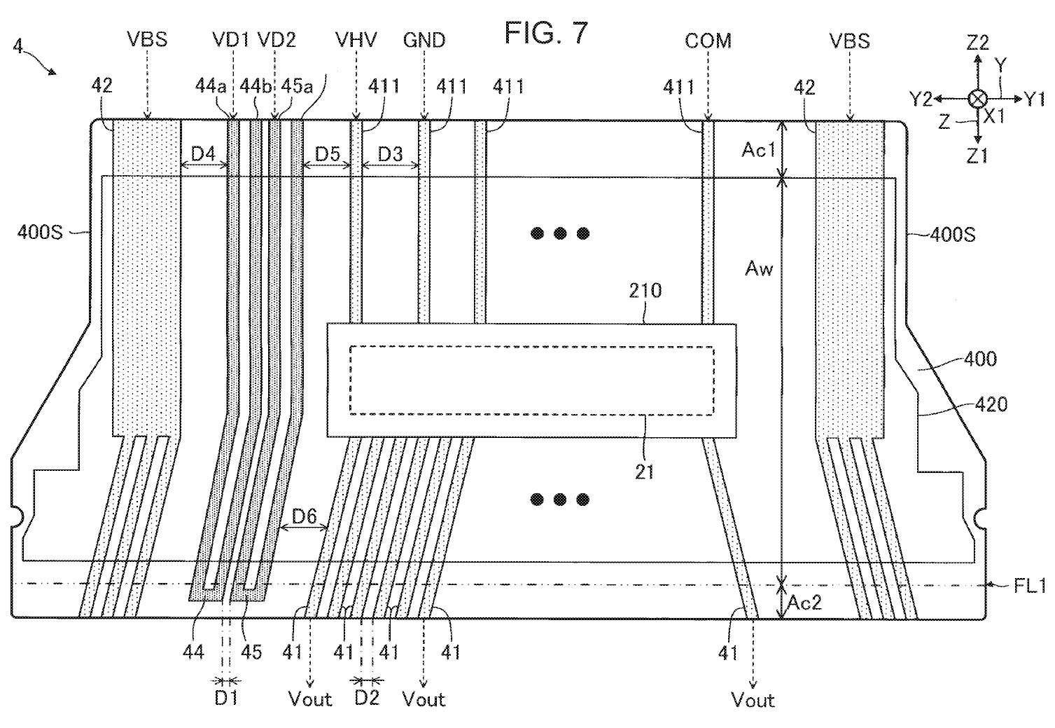

Furthermore, the control circuit 11 receives a detection signal Vd from the liquid ejecting head 200 to detect a short circuit between the first dummy wiring 44 and the second dummy wiring 45 of the flexible substrate 4 shown in FIG. 7 and the like, which will be described later. For example, the control circuit 11 determines a short circuit between the first dummy wiring 44 and the second dummy wiring 45 based on the detection signal Vd. The short circuit between the first dummy wiring 44 and the second dummy wiring 45 will be described later with reference to FIG. 7. The control circuit 11 is an example of a “determination circuit”.

Further, the control circuit 11 outputs a base drive signal dO, which is a digital signal, to the drive circuit 12. The drive circuit 12 converts the base drive signal dO into an analog signal, amplifies the analog signal, and generates a drive signal COM, and outputs the generated drive signal COM to the liquid ejecting head 200.

The reference voltage signal output circuit 13 generates a reference voltage signal VBS and outputs the generated signal to the liquid ejecting head 200. The reference voltage signal VBS is a constant potential signal that serves as a reference for driving a piezoelectric element E (to be described later) of the liquid ejecting head 200. For example, the reference voltage signal VBS is a DC voltage signal with a constant potential.

The liquid ejecting head 200 has a plurality of liquid ejecting modules 20 and a plurality of detection circuits 25 corresponding to the plurality of liquid ejecting modules 20. Note that the plurality of liquid ejecting modules 20 all have the same configuration. Further, the plurality of detection circuits 25 all have the same configuration. The plurality of detection circuits 25 are mounted on, for example, a wiring substrate 27.

Each liquid ejecting module 20 includes, for example, a drive signal selection circuit 21 mounted on the flexible substrate 4 and a plurality of piezoelectric elements E included in the head chip 3. The control signal CTRLh, the drive signal COM, and the reference voltage signal VBS output from the control unit 10 are input to each liquid ejecting module 20 via the wiring substrate 27. Specifically, the control signal CTRLh and the drive signal COM are input to the drive signal selection circuit 21. The drive signal selection circuit 21 generates the drive signal Vout for each piezoelectric element E by selecting or not selecting the signal waveform of the drive signal COM based on the control signal CTRLh. The drive signal selection circuit 21 inputs each drive signal Vout to one end of the corresponding piezoelectric element E individually. Further, the reference voltage signal VBS is commonly input to the other end of each of the plurality of piezoelectric elements E. Each of the plurality of piezoelectric elements E is driven by a potential difference between the supplied drive signal Vout and the reference voltage signal VBS. Then, the amount of liquid corresponding to the driving of each of the plurality of piezoelectric elements E is ejected. In this way, the drive signal selection circuit 21 selects whether to supply the drive signal COM to each of the plurality of piezoelectric elements E. The drive signal selection circuit 21 is an example of a “selection circuit”, and the plurality of piezoelectric elements E are an example of a “plurality of drive elements”.

The detection circuit 25 is electrically coupled to, for example, one or both of a first dummy wiring 44 and a second dummy wiring 45 provided on the flexible substrate 4 and shown in FIG. 7 to be described later. The detection circuit 25 then outputs the detection signal Vd for detecting a short circuit between the first dummy wiring 44 and the second dummy wiring 45. For example, the detection circuit 25 generates the detection signal Vd based on a change in the current flowing through the first dummy wiring 44 or the second dummy wiring 45, or a change in the voltage of the first dummy wiring 44 or the second dummy wiring 45, and outputs the generated detection signal Vd to the control unit 10. A known circuit can be employed as the detection circuit 25 for detecting a short circuit between two wirings.

### 1-2. Liquid Ejecting Head 200

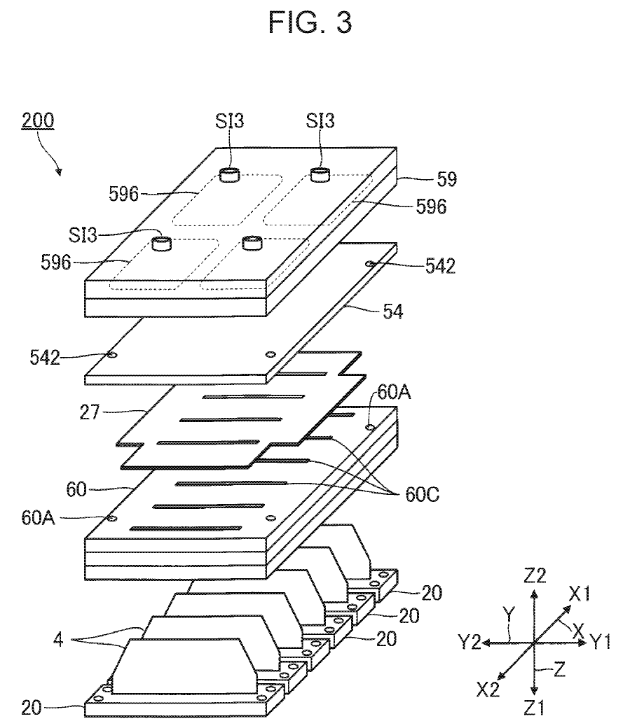

FIG. 3 is an exploded perspective view of the liquid ejecting head 200 shown in FIG. 2. The liquid ejecting head 200 shown in FIG. 3 includes a filter portion 59, a communication member 54, a wiring substrate 27, a liquid distribution portion 60, and a plurality of liquid ejecting modules 20. The filter portion 59, the communication member 54, the wiring substrate 27, the liquid distribution portion 60, and the plurality of liquid ejecting modules 20 are arranged in this order in the Z1 direction.

In the shown example, the plurality of liquid ejecting modules 20 are six liquid ejecting modules 20. The plurality of liquid ejecting modules 20 are arranged in a direction along the X-axis at intervals from each other. Each liquid ejecting module 20 includes the flexible substrate 4.

The filter portion 59 is an element that removes air bubbles and foreign matter contained in the liquid supplied from the liquid container 9. The filter portion 59 is a flat plate made of a resin material. Furthermore, for example, the filter portion 59 is provided with four filters 596 according to the type of liquid. Furthermore, the filter portion 59 is provided with four supply ports SI3 for supplying the liquid from the liquid container 9 to the filter portion 59.

The communication member 54 is a flat plate made of an elastic material. The communication member 54 is formed with a plurality of through holes 542 through which a liquid from the filter portion 59 flows.

The wiring substrate 27 is a substrate on which wiring is formed for transmitting various signals such as the drive signal COM and power supply voltage to each liquid ejecting module 20. The wiring substrate 27 is provided in common to the plurality of liquid ejecting modules 20. The wiring substrate 27 has, for example, the detection circuit 25 shown in FIG. 2 mounted thereon. Furthermore, the wiring substrate 27 is formed with coupling terminals (not shown) to which the flexible substrates 4 of the respective liquid ejecting modules 20 are electrically coupled, and the wiring substrate 27 and the flexible substrates 4 are electrically coupled.

The liquid distribution portion 60 is a member that distributes the liquid supplied via each through hole 542 of the communication member 54 to each liquid ejecting module 20. The liquid distribution portion 60 is composed of a stack of a plurality of flat plate members. The liquid distribution portion 60 is made of a resin material. The liquid distribution portion 60 is also provided with a through hole 60C through which the flexible substrate 4 is inserted.

The liquid ejecting head 200 in FIG. 3 is an example, and any element may be further added to the liquid ejecting head 200 or may be omitted. For example, the liquid distribution portion 60 and a holder may be integrally configured. Furthermore, the disposition relationship of the elements of the liquid ejecting head 200 is not limited to the example shown in FIG. 3. For example, the wiring substrate 27 may be located to the side of the plurality of liquid ejecting modules 20.

### 1-3. Liquid Ejecting Module 20

FIG. 4 is an explanatory view for describing a schematic structure of the liquid ejecting module 20 shown in FIG. 3. The upper diagram in FIG. 4 is an exploded perspective view of the liquid ejecting module 20, and the lower diagram in FIG. 4 is a cross-sectional view taken along line a-a shown in the exploded perspective view. The a-a cross section is parallel to the XZ plane and passes through a supply port 361, which will be described later. The liquid ejecting module 20 includes a head chip 3 and a flexible substrate 4. The Z-axis is an axis along the direction in which the liquid is ejected by the liquid ejecting head 200.

As illustrated in the exploded perspective view of FIG. 4, the head chip 3 of the liquid ejecting module 20 has a plurality of nozzles N arranged along the Y-axis. The plurality of nozzles N are divided into a first nozzle row La and a second nozzle row Lb that are arranged in parallel at intervals along the X-axis. The second nozzle row Lb is arranged in parallel in a direction along the first nozzle row La. Each of the first nozzle row La and the second nozzle row Lb is a set of a plurality of nozzles N arranged linearly along the Y-axis. The liquid ejecting module 20 has a structure in which elements related to each nozzle N of the first nozzle row La and elements related to each nozzle N of the second nozzle row Lb are disposed in a substantially plane-symmetrical manner. In the following, the elements corresponding to the first nozzle row La will be mainly described, and the description of the elements corresponding to the second nozzle row Lb will be omitted as appropriate.

As illustrated in FIG. 4, the head chip 3 has a flow path forming substrate 31, a pressure chamber substrate 32, a vibration plate 33, a nozzle substrate 37, a vibration absorbing body 38, a plurality of piezoelectric elements E, a sealing body 35, and a flow path housing portion 36. Each of the flow path forming substrate 31, the pressure chamber substrate 32, the vibration plate 33, the nozzle substrate 37, the vibration absorbing body 38, the sealing body 35, and the flow path housing portion 36 is an elongated plate-shaped member along the Y-axis. Also, the nozzle substrate 37, the flow path forming substrate 31, the pressure chamber substrate 32, the vibration plate 33, and the sealing body 35 are arranged in this order in the Z2 direction. In addition, the vibration plate 33 and the plurality of piezoelectric elements E constitute a piezoelectric substrate 30. The piezoelectric substrate 30 is an example of an “actuator substrate”.

The nozzle substrate 37 is a plate-shaped member in which the plurality of nozzles N are formed. The nozzle substrate 37 includes the first nozzle row La and the second nozzle row Lb. Each of the plurality of nozzles N is a circular through hole that ejects a liquid. The nozzle substrate 37 is bonded to the surface of the flow path forming substrate 31 in the Z1 direction with, for example, an adhesive.

The flow path forming substrate 31 forms a flow path through which the liquid flows. Specifically, the flow path forming substrate 31 is formed with a space Ra, a relay liquid chamber Rb, a plurality of supply flow paths 312, and a plurality of communication flow paths 314. The space Ra is an opening formed in an elongated shape along the Y-axis. Each of the supply flow path 312 and the communication flow path 314 is a through hole formed for each of nozzles N. Each communication flow path 314 overlaps with a corresponding nozzle N in a plan view seen from the Z1 direction. The relay liquid chamber Rb is a space formed in an elongated shape along the Y-axis across the plurality of nozzles N, and communicates the space Ra and the plurality of supply flow paths 312 with each other. Furthermore, the pressure chamber substrate 32 is bonded to the Z2 direction surface of the flow path forming substrate 31 with an adhesive.

The pressure chamber substrate 32 is coupled to the piezoelectric substrate 30. The pressure chamber substrate 32 is provided with a pressure chamber C1 whose volume changes with deformation of the piezoelectric substrate 30. The pressure chamber substrate 32 can also be considered to partition the pressure chambers C1. The pressure chamber substrate 32 is made of silicon oxide. The liquid to be ejected from the nozzle N is stored in the pressure chamber C1. The pressure chamber C1 is a space located between the nozzle substrate 37 and the vibration plate 33 and formed by the inner wall surface of the pressure chamber substrate 32. The pressure chamber C1 is formed for each of nozzles N. The pressure chamber C1 is an elongated space extending in the X1 direction. The plurality of pressure chambers C1 are arranged along the Y-axis. Each pressure chamber C1 communicates with the communication flow path 314 and the supply flow path 312. Accordingly, the pressure chamber C1 communicates with the nozzle N via the communication flow path 314, and also communicates with the space Ra via the supply flow path 312 and the relay liquid chamber Rb.

The nozzle substrate 37, the flow path forming substrate 31, and the pressure chamber substrate 32 are manufactured by processing a silicon (Si) single crystal substrate using semiconductor manufacturing techniques such as photolithography and etching, for example. However, any well-known materials and methods can be employed for manufacturing the nozzle substrate 37, the flow path forming substrate 31, and the pressure chamber substrate 32.

The vibration plate 33 of the piezoelectric substrate 30 is coupled to the surface of the pressure chamber substrate 32 opposite to the flow path forming substrate 31. The vibration plate 33 is disposed above the pressure chamber C1 and is elastically deformable. The vibration plate 33 vibrates by driving the piezoelectric element E. The vibration plate 33 is a plate-shaped member formed in a long rectangular shape along the Y-axis in a plan view. The vibration plate 33 and the pressure chamber C1 may be integrally formed, or may be formed as separate bodies and bonded with an adhesive or the like.

The piezoelectric element E is formed at the surface of the vibration plate 33 opposite to the pressure chamber C1. The piezoelectric element E is provided for each of pressure chambers C1. The piezoelectric element E is formed in an elongated shape along the X-axis in a plan view. The piezoelectric element E is a drive element that is driven by application of the drive signal Vout, and applies a pressure to the liquid in the pressure chamber C1.

The sealing body 35 is bonded to the vibration plate 33 with, for example, an adhesive. The sealing body 35 is a structure that protects the plurality of piezoelectric elements E and reinforces a mechanical strength of the pressure chamber substrate 32 and the vibration plate 33. The sealing body 35 has a recess formed at the surface facing the vibration plate 33. A plurality of piezoelectric elements E are accommodated inside the recess. Also, the sealing body 35 has a space 353 through which the flexible substrate 4 is inserted.

Furthermore, the vibration absorbing body 38 is bonded to the surface of the flow path forming substrate 31 in the Z1 direction with, for example, an adhesive. The vibration absorbing body 38 is a flexible film that forms the wall surface of the space Ra.

The flow path housing portion 36 is bonded to the flow path forming substrate 31 with, for example, an adhesive. The flow path housing portion 36 is a case for storing the liquid to be supplied to the plurality of pressure chambers C1. The flow path housing portion 36 is formed by injection molding of a resin material, for example. In the flow path housing portion 36, a space Rc, a supply port 361, and a space 362 are formed. The supply port 361 is a pipeline through which the liquid is supplied from the liquid container 9 via the liquid distribution portion 60, and communicates with the space Rc. The space Rc communicates with the space Ra of the flow path forming substrate 31. The space formed by the space Rc and the space Ra functions as a liquid storage chamber R that stores the liquid to be supplied to the plurality of pressure chambers C1. The liquid supplied from the liquid container 9 and passed through the supply port 361 is stored in the liquid storage chamber R. The liquid stored in the liquid storage chamber R is branched from the relay liquid chamber Rb to each supply flow path 312 and is supplied in parallel to the plurality of pressure chambers C1. Further, the space 362 overlaps with the space 353 of the sealing body 35 in a plan view. The flexible substrate 4 is inserted through the space 353 and the space 362.

The flexible substrate 4 is coupled to the vibration plate 33. The flexible substrate 4 electrically couples the piezoelectric substrate 30 and the wiring substrate 27 to each other. The flexible substrate 4 is a mount component on which the plurality of wirings are formed. For example, the flexible substrate 4 is a flexible printed circuit (FPC) or a chip on film (COF), which is a flexible circuit substrate. The flexible substrate 4 is mounted with the drive signal selection circuit 21 shown in FIG. 2.

In the liquid ejecting module 20 shown in FIG. 4, when the piezoelectric element E is flexibly deformed by application of a voltage, the vibration plate 33 is flexibly deformed in a direction that reduces the volume of the pressure chamber C1. That is, when the piezoelectric element E is flexibly deformed by application of a voltage, the vibration plate 33 vibrates. As a result, the pressure in the pressure chamber C1 changes, and the liquid in the pressure chamber C1 is ejected from the nozzles N. After the liquid is ejected, the piezoelectric element E is restored to its original position.

The configuration of the liquid ejecting module 20 is not limited to the example shown in FIG. 4. For example, the liquid ejecting module bmay not have some of the plurality of elements shown in FIG. 4, or may have other elements instead of some of the plurality of elements shown in FIG. 4. Alternatively, the liquid ejecting module 20 may have other elements in addition to the plurality of elements shown in FIG. 4.

### 1-4. Piezoelectric Substrate 30

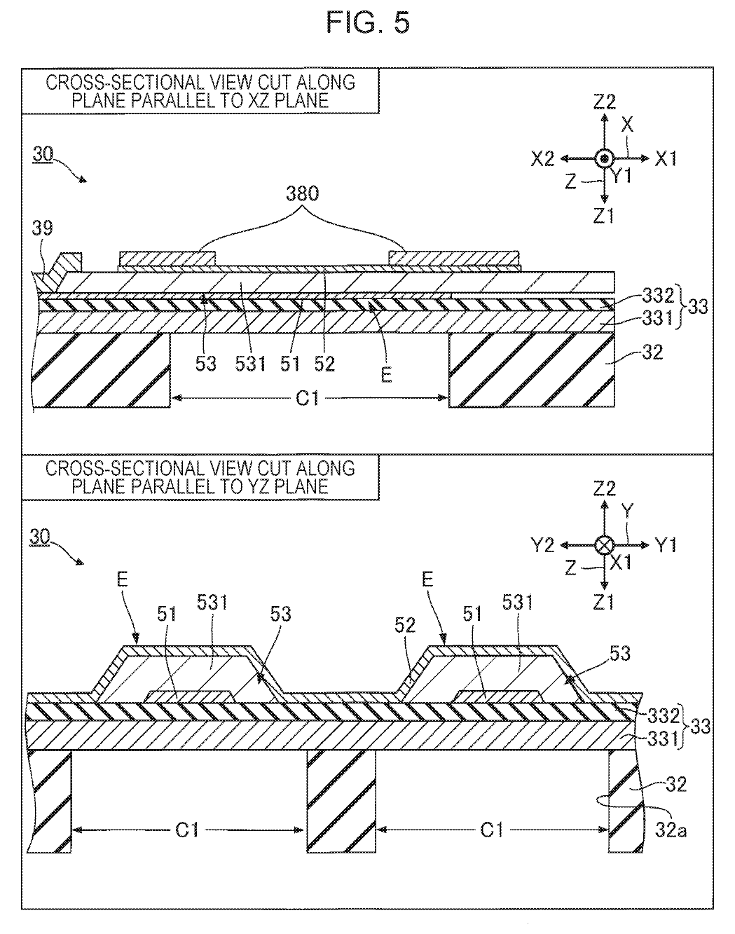

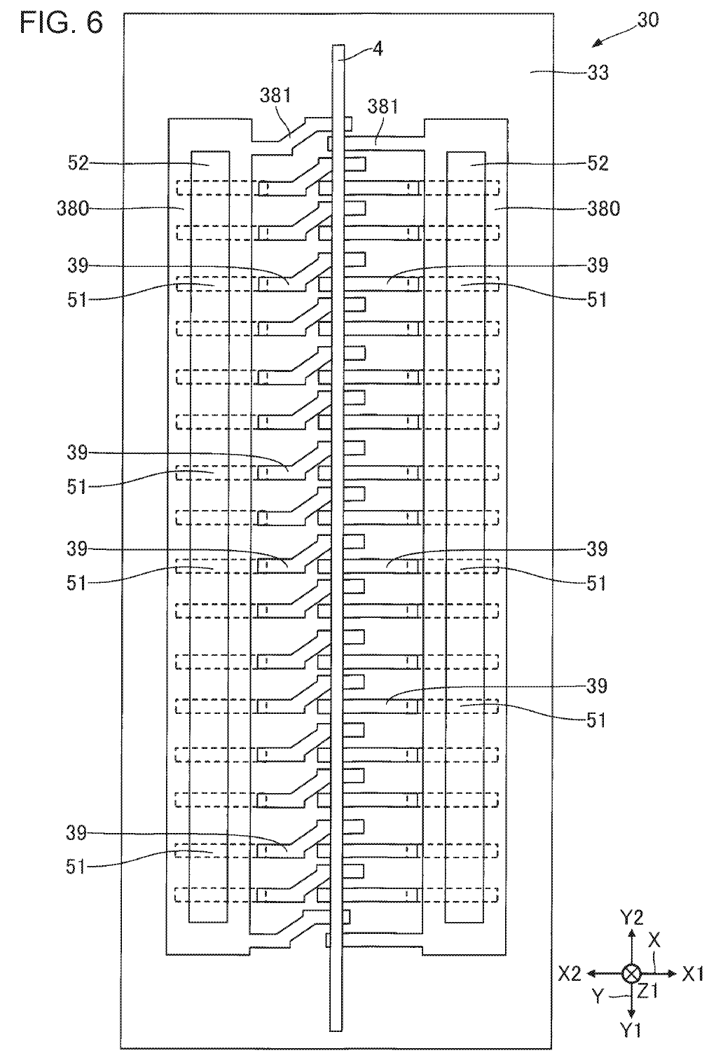

FIG. 5 is a cross-sectional view showing the piezoelectric substrate 30 of FIG. 4. FIG. 6 is a plan view showing the piezoelectric substrate 30 of FIG. 4.

The upper diagram in FIG. 5 is a cross-sectional view of the piezoelectric substrate 30 when the piezoelectric substrate 30 is cut along a plane parallel to the XZ plane to include the piezoelectric element E. The lower diagram in FIG. 5 is a cross-sectional view of the piezoelectric substrate 30 when the piezoelectric substrate 30 is cut along a plane parallel to the YZ plane to include the piezoelectric element E. In FIG. 5, the pressure chamber substrate 32 is also shown in order to facilitate understanding of the piezoelectric substrate 30.

As shown in FIG. 5, the vibration plate 33 of the piezoelectric substrate 30 is formed of a stack including, for example, a first layer 331 and a second layer 332. The first layer 331 is in contact with the pressure chamber substrate 32. The second layer 332 is disposed above the first layer 331. The second layer 332 is located at a position closer to the piezoelectric element E than the first layer 331. The second layer 332 is formed of an insulating material such as zirconium oxide (ZrOₓ). The first layer 331 is formed by, for example, thermally oxidizing a portion of the pressure chamber substrate 32. The second layer 332 is formed by a well-known film formation technique such as sputtering. The vibration plate 33 may be made up of one layer or three or more layers.

The piezoelectric element E mainly has individual electrodes 51, a piezoelectric layer 53, and a common electrode 52. The individual electrodes 51, the piezoelectric layer 53, and the common electrode 52 are stacked in a direction along the Z-axis, which is a stacking direction. In addition, the piezoelectric layer 53 has a plurality of piezoelectric portions 531. Note that the piezoelectric layer 53 is not shown in FIG. 6.

The individual electrodes 51 are provided above the vibration plate 33. The individual electrodes 51 are individual electrodes provided for each piezoelectric element E. The drive signal Vout is applied to the individual electrode 51. The individual electrodes 51 are formed in an elongated shape along the X-axis. The plurality of individual electrodes 51 are arranged at intervals along the Y-axis. The individual electrodes 51 include a conductive material such as metal.

The piezoelectric layer 53 is provided above the individual electrodes 51. The piezoelectric layer 53 is, for example, a band-shaped dielectric film that extends continuously along the Y-axis across the plurality of piezoelectric elements E. The piezoelectric layer 53 has, for example, a band shape extending along the Y-axis, and is separated into individual piezoelectric elements E by forming a plurality of notches. By forming the plurality of notches, the piezoelectric layer 53 has the plurality of piezoelectric portions 531. The plurality of individual electrodes 51 described above are provided in correspondence with the plurality of piezoelectric portions 531. The piezoelectric layer 53 is made of a piezoelectric material having a perovskite crystal structure, for example.

Examples of the piezoelectric material include lead titanate (PbTiO₃), lead zirconate titanate (PZT:Pb(Zr, Ti)O₃), lead zirconate (PbZrO₃), lead lanthanum titanate ((Pb, La), TiO₃), lead lanthanum titanate zirconate ((Pb, La)(Zr, Ti)O₃), lead zirconate niobate titanate (Pb(Zr, Ti, Nb)O₃), and lead magnesium niobate zirconate titanate (Pb(Zr, Ti)(Mg, Nb)O₃). Among them, lead zirconate titanate (PZT) is preferably used as the constituent material of the piezoelectric layer 53.

The common electrode 52 is provided above the piezoelectric layer 53. The common electrode 52 is a band-shaped common electrode that extends continuously along the Y-axis across the plurality of piezoelectric elements E. The common electrode 52 is commonly provided to the plurality of piezoelectric portions 531 described above. The reference voltage signal VBS is applied to the common electrode 52. The common electrode 52 includes a conductive material such as a metal.

A voltage corresponding to a difference between the reference voltage signal VBS applied to the common electrode 52 and the drive signal Vout corresponding to the ejection amount supplied to the individual electrode 51 is applied to the piezoelectric portion 531. When a voltage is applied between the individual electrode 51 and the common electrode 52, the piezoelectric portion 531 is deformed, and the piezoelectric element E is flexibly deformed, that is, vibrates by the deformation of the piezoelectric portion 531.

In addition, a weight portion 380 is provided above the common electrode 52 in contact with the common electrode 52.

As shown in FIG. 6, the weight portion 380 has a rectangular frame shape. The weight portion 380 functions as a weight for suppressing excessive vibration of the vibration plate 33. Furthermore, a coupling electrode 381 is coupled to the weight portion 380. The coupling electrode 381 is coupled to the flexible substrate 4. The reference voltage signal VBS is applied to the common electrode 52 described above via the coupling electrode 381 and the weight portion 380. Note that the weight portion 380 includes a metal such as gold.

As shown in FIGS. 5 and 6, a coupling electrode 39 is coupled to each of the individual electrodes 51 described above. The coupling electrode 39 is coupled to the flexible substrate 4. The drive signal Vout is applied to the above-described individual electrode 51 via the coupling electrode 39. Note that the coupling electrode 39 includes a metal such as gold.

In an example shown in FIG. 5, the individual electrode 51 is provided below the piezoelectric layer 53, and the common electrode 52 is provided above the piezoelectric layer 53. However, the common electrode 52 may be provided below the piezoelectric layer 53 and the individual electrode 51 may be provided above the piezoelectric layer 53.

### 1-5. Flexible Substrate 4

FIG. 7 is a view showing the flexible substrate 4 shown in FIG. 4. In FIG. 7, a plan view of the flexible substrate 4 is shown schematically. For ease of understanding, FIG. 7 also shows the portion of the wiring provided on the flexible substrate 4 that is covered with a cover film 420 to be described later. Also, in FIG. 7, an identification mark for identifying the flexible substrate 4, an alignment mark used for positioning the flexible substrate 4 with respect to other members, and the like are not shown. The identification mark and the alignment mark may be omitted as appropriate.

The flexible substrate 4 has, for example, a first coupling area Ac1 coupled to the wiring substrate 27 at the end portion in the Z2 direction, and a second coupling area Ac2 coupled to the piezoelectric substrate 30 at the end portion in the Z1 direction. The flexible substrate 4 has a wiring area Aw between the first coupling area Ac1 and the second coupling area Ac2. As shown in the cross-sectional view of FIG. 4, the flexible substrate 4 is bent at substantially 90 degrees at a bent portion FL1 of the boundary portion between the second coupling area Ac2 and the wiring area Aw. Note that FIG. 7 shows the flexible substrate 4 in a state of not being bent.

As described above, the second coupling area Ac2 is a portion that is coupled to the piezoelectric substrate 30, and is a portion that is bent relative to the wiring area Aw and spreads in the X-Y plane. The wiring area Aw is a portion that is not directly coupled to the piezoelectric substrate 30. The wiring area Aw is a portion that spreads in the Y-Z plane and extends from the piezoelectric substrate 30 in the Z2 direction. In the wiring area Aw, a mount component 210, which is an integrated circuit, is provided. The mount component 210 is mounted with, for example, the drive signal selection circuit 21 shown in FIG. 2. The mount component 210 is an example of a “drive component”. In addition, most of the wiring area Aw is covered with an insulating cover film 420 made of resin such as polyimide.

The flexible substrate 4 includes, for example, a base film 400, a plurality of electrical wirings 411, a plurality of drive signal wirings 41, a plurality of constant voltage wirings 42, a first dummy wiring 44, a second dummy wiring 45, and a mount component 210. The flexible substrate 4 does not necessarily have to include the mount component 210. In this case, the drive signal selection circuit 21 is provided on the wiring substrate 27 coupled to the first coupling area Ac1 of the flexible substrate 4 or on a separate substrate. When the flexible substrate 4 does not have the drive signal selection circuit 21, for example, one end and the other end of each of the plurality of drive signal wirings 41 are disposed in the first coupling area Ac1 and the second coupling area Ac2, respectively.

The base film 400 is an insulating material made of resin such as polyimide. The base film 400 is a flexible film-like member. On the base film 400, the plurality of drive signal wirings 41, the plurality of constant voltage wirings 42, the first dummy wiring 44, and the second dummy wiring 45 are formed. As described above, these wirings are covered with the cover film 420 in most of the wiring area Aw. The directions in which the plurality of drive signal wirings 41, the plurality of constant voltage wirings 42, the first dummy wirings 44, and the second dummy wirings 45 are respectively arranged are substantially the same, that is, substantially along the Z-axis.

The plurality of electrical wirings 411 are located in the Z2 direction relative to the plurality of drive signal wirings 41. The plurality of electrical wirings 411 are located, for example, at the center portion of the base film 400 in the Y-axis. The plurality of electrical wirings 411 are arranged along the Y-axis at intervals from each other. The plurality of electrical wirings 411 are input wirings for inputting input signals such as a drive signal COM, a latch signal, and a clock signal to the mount component 210, and are coupled to the wiring substrate 27 and the mount component 210. Note that the plurality of electrical wirings 411 may also include wirings used as power supply voltages for the mount component 210 and various components of the liquid ejecting module 20. The plurality of electrical wirings 411 include two wirings to which a high potential VHV and a ground potential GND are respectively supplied, for example. The high potential VHV is, for example, the highest potential supplied to the liquid ejecting module 20. In the present embodiment, a case where the potential difference between the high potential VHV and the ground potential GND is about 42 V is assumed. In the following description, unless otherwise specified, the numerical example of a potential of interest means the potential difference of the potential of interest with respect to the ground potential GND. Hereinafter, the electrical wiring 411 to which the high potential VHV is supplied will also be referred to as an electrical wiring 411 of the high potential VHV, and the electrical wiring 411 to which the ground potential GND is supplied will also be referred to as an electrical wiring 411 of the ground potential GND.

In the example shown in FIG. 7, the electrical wiring 411 of the high potential VHV and the electrical wiring 411 of the ground potential GND are adjacent to each other. Therefore, when attention is paid to the potential difference between wirings adjacent to each other, the electrical wiring 411 of the high potential VHV and the electrical wiring 411 of the ground potential GND are wirings in which ion migration is likely to occur. Ion migration is a phenomenon in which, for example, a metal contained in the wiring on the flexible substrate 4 is ionized and moves. Specifically, ion migration is a phenomenon in which, for example, when moisture adheres to the flexible substrate 4 or the flexible substrate 4 is exposed to a high humidity environment, a voltage is applied to the wiring on the flexible substrate 4, causing the metal contained in the anode wiring to ionize and move to the cathode wiring. Ion migration is also called electrochemical migration. Hereinafter, ion migration, that is, electrochemical migration, may be simply referred to as migration.

The plurality of drive signal wirings 41 are located in the Z1 direction on the base film 400 and are provided at the center portion of the base film 400 in the Y-axis. The plurality of drive signal wirings 41 are arranged along the Y-axis at intervals from each other. The direction along the Y-axis corresponds to an “arrangement direction”. The plurality of drive signal wirings 41 are an example of a “plurality of individual signal wirings”. The plurality of drive signal wirings 41 are output wirings that transmit drive signals Vout to the plurality of piezoelectric elements E, are wired from the mount component 210 to the second coupling area Ac2, and are coupled to the mount component 210 and the piezoelectric substrate 30. The plurality of drive signal wirings 41 correspond in a one-to-one manner to the plurality of individual electrodes 51.

The plurality of constant voltage wirings 42 are located outside the plurality of drive signal wirings 41 on the base film 400 in the Y-axis, and are disposed to interpose the group of the plurality of drive signal wirings 41 in the Y-axis. The plurality of constant voltage wirings 42 are disposed to interpose the group of a plurality of electrical wirings 411 in the Y-axis direction. The constant voltage wiring 42 is not coupled to the mount component 210, and is arranged from the first coupling area Ac1 on the input side located in the Z2 direction of the flexible substrate 4 to the second coupling area Ac2 on the output side located in the Z1 direction. That is, one end and the other end of the constant voltage wiring 42 are disposed respectively in the first coupling area Ac1 and the second coupling area Ac2. The constant voltage wiring 42 is a single wiring in the first coupling area Ac1, and is divided into a plurality of wirings in the second coupling area Ac2. In the example shown in FIG. 7, the constant voltage wiring 42 is a single wiring in the first coupling area Ac1, and is divided into three wirings in the second coupling area Ac2. The plurality of constant voltage wirings 42 in the second coupling area Ac2 are arranged along the Y-axis at intervals from each other.

By dividing the constant voltage wiring 42 into a plurality of wirings in the second coupling area Ac2, the surface area to which adhesive adheres when the plurality of wirings are coupled can be increased. As a result, the flexible substrate 4 is less likely to peel off from the piezoelectric substrate 30, and the breaking of the constant voltage wiring 42 can be suppressed. Furthermore, since the constant voltage wiring 42 is divided into a plurality of wirings in the second coupling area Ac2, a contact failure can be suppressed even when misalignment occurs when coupling to the coupling electrode 381 of the piezoelectric substrate 30 in the second coupling area Ac2.

Note that the number of constant voltage wirings 42 in the second coupling area Ac2 is not limited to three, but may be one or two. Alternatively, the number of constant voltage wirings 42 in the second coupling area Ac2 may be four or more. Further, the constant voltage wiring 42 may also be divided into a plurality of wirings in the first coupling area Ac1 on the input side located in the Z2 direction.

The constant voltage wiring 42 is held at a constant voltage. The reference voltage signal VBS is applied to the constant voltage wiring 42. The potential of the reference voltage signal VBS may be the ground potential GND or may be a potential different from the ground potential GND. In the present embodiment, a case where the potential of the reference voltage signal VBS is higher than the ground potential GND is assumed. For example, in the present embodiment, a case where the potential of the reference voltage signal VBS is about 6 V is assumed. The plurality of constant voltage wirings 42 are electrically coupled to the common electrode 52.

In the example shown in FIG. 7, the flexible substrate 4 does not have any other wiring between an end side 400S of the flexible substrate 4 in the Y1 direction and the constant voltage wiring 42 in the direction along the Y-axis. Similarly, the flexible substrate 4 does not have any other wiring between an end side 400S of the flexible substrate 4 in the Y2 direction and the constant voltage wiring 42 in the direction along the Y-axis. That is, the constant voltage wiring 42 is provided on the outermost side of the flexible substrate 4 in the Y-axis. The end side 400S is a side that extends in a direction that intersects with the extension direction of the first nozzle row La and along the Y-Z plane. By providing the constant voltage wiring 42 on the outermost side of the flexible substrate 4, noise from other wirings can be suppressed from being carried onto the constant voltage wiring 42.

The first dummy wiring 44 and the second dummy wiring 45 are wirings adjacent to each other for detecting deterioration of the flexible substrate 4 caused by migration. For example, the first dummy wirings 44 and the second dummy wirings 45 are disposed outside the plurality of electrical wirings 411 and the plurality of drive signal wirings 41. In the example shown in FIG. 7, the first dummy wiring 44 and the second dummy wiring 45 are disposed between the group of the plurality of drive signal wirings 41 and the plurality of electrical wirings 411 and the constant voltage wiring 42. In the following, the group of the plurality of drive signal wirings 41 and the plurality of electrical wirings 411 will also be referred to as a central wiring group. Further, the first dummy wiring 44 is disposed between the constant voltage wiring 42 and the second dummy wiring 45, and the second dummy wiring 45 is disposed between the first dummy wiring 44 and the central wiring group.

The first dummy wiring 44 and the second dummy wiring 45 are each disposed to reciprocate along the Z-axis. For example, an end portion 44a and an end portion 44b of the first dummy wiring 44 are located in the first coupling area Ac1, and the folded-back portion of the first dummy wiring 44 is located in the second coupling area Ac2. Similarly, an end portion 45a and an end portion 45b of the second dummy wiring 45 are located in the first coupling area Ac1, and the folded-back portion of the second dummy wiring 45 is located in the second coupling area Ac2.

For example, one of the end portion 44a and the end portion 44b of the first dummy wiring 44 is coupled to a terminal (not shown) to which a potential VD1 of the wiring substrate 27 is supplied, and the other of the end portion 44a and the end portion 44b of the first dummy wiring 44 is electrically coupled to the detection circuit 25. In addition, one of the end portion 45a and the end portion 45b of the second dummy wiring 45 is coupled to a terminal (not shown) to which a potential VD2 different from the potential VD1 of the wiring substrate 27 is supplied, and the other of the end portion 45a and the end portion 45b of the second dummy wiring 45 is electrically coupled to the detection circuit 25. Note that only one of the first dummy wiring 44 and the second dummy wiring 45 may be electrically coupled to the detection circuit 25.

In the example shown in FIG. 7, the potential VD1 is supplied to the end portion 44a of the first dummy wiring 44 that is not adjacent to the second dummy wiring 45, out of the end portion 44a and the end portion 44b. Furthermore, the potential VD2 is supplied to the end portion 45a of the second dummy wiring 45 adjacent to the first dummy wiring 44, out of the end portion 45a and the end portion 45b of the second dummy wiring 45. Then, one or both of the end portion 44b of the first dummy wiring 44 and the end portion 45b of the second dummy wiring 45 are electrically coupled to the detection circuit 25.

In FIG. 7, a case where the potential VD1 is the same as the potential of the reference voltage signal VBS, and the potential VD2 is the same as the high potential VHV is assumed. Note that the term “same potential” includes not only the case where the potential is exactly the same, but also the case where there is a difference in the degree of error such as a design error or an operational error.

One of the first dummy wiring 44 and the second dummy wiring 45 is an example of a “first wiring”, and the other of the first dummy wiring 44 and the second dummy wiring 45 is an example of a “second wiring”. The constant voltage wiring 42 is an example of a “third wiring”, and the electrical wiring 411 of the high potential VHV is an example of a “fourth wiring”.

The materials of the plurality of drive signal wirings 41, the plurality of constant voltage wirings 42, the first dummy wiring 44, the second dummy wiring 45, and the plurality of electrical wirings 411 are not particularly limited as long as they are conductive materials, and include metals such as gold (Au), copper (Cu), titanium (Ti), tungsten (W), nickel (Ni), chromium (Cr), platinum (Pt), aluminum (Al), and tin (Sn), for example. The plurality of drive signal wirings 41, the plurality of constant voltage wirings 42, the first dummy wirings 44, the second dummy wirings 45, and the plurality of electrical wirings 411 are examples of a “plurality of wirings”.

In the present embodiment, the maximum voltage applied to the drive signal wiring 41 is, for example, about 42 V. However, the voltages applied to the wirings such as the drive signal wiring 41 and the constant voltage wiring 42 are not limited to the above example, and may be set as desired.

Here, when migration occurs due to moisture adhering to the flexible substrate 4 or due to the flexible substrate 4 being exposed to a high humidity environment, there is a concern that the drive signal wirings 41 may be coupled to each other or the drive signal wiring 41 and the constant voltage wiring 42 may be coupled to each other, causing a short circuit.

For example, in a case in which UV ink containing a monomer or the like that is cured by ultraviolet irradiation is used, when the monomer contained in the UV ink permeates the adhesive that couples the flow paths, the space that accommodates the flexible substrate 4 becomes highly humid. In this case, the portion of the wiring of the flexible substrate 4 that is exposed to the space that accommodates the flexible substrate 4 is exposed to high humidity air, and thus there is a concern that migration may occur in the wiring in the portion exposed to the space that accommodates the flexible substrate 4, causing a short circuit between the wirings. That is, there is a concern that migration may occur in the portions of the plurality of wirings provided on the flexible substrate 4 that are not covered with the cover film 420, causing short circuits between the wirings. For example, the wiring in the portion not covered with the cover film 420 corresponds to the wiring in the first coupling area Ac1 and the second coupling area Ac2. Therefore, the wiring in the first coupling area Ac1 and the second coupling area Ac2 is likely to cause short circuits due to migration. In particular, the wiring in the second coupling area Ac2 is likely to cause short circuits due to migration because the interval between the wirings is narrow.

Furthermore, for example, in the wiring in the portion covered with the cover film 420, the monomer that has permeated the flow path member may enter pinholes or the like in the cover film 420. In this case, it is considered that the copper (Cu) contained in the wiring reacts with the residue of monomer or chlorine (Cl) that has entered pinholes or the like, causing the wiring to lift off the base film 400 and exposing the copper (Cu) contained in the wiring. It is considered that when a potential difference is applied between a wiring with exposed copper (Cu) and a wiring adjacent to that wiring, the monomer becomes a solvent, causing electrolytic corrosion between the two wirings with a potential difference, resulting in migration. In this way, it is considered that a short circuit due to migration may occur even in the wiring in the portion covered with the cover film 420.

When a short circuit occurs between the drive signal wirings 41, the drive signal Vout cannot be transmitted appropriately to the piezoelectric element E, resulting in a liquid ejection failure or a serious error. Therefore, in the present embodiment, by detecting short circuits between wirings that are more likely to short-circuit than between drive signal wirings 41, the life of the flexible substrate 4 is predicted before a short circuit occurs between the drive signal wirings 41, thereby suppressing the occurrence of liquid ejection failures or serious errors. In the present embodiment, the first dummy wiring 44 and the second dummy wiring 45 are used as wirings that are more likely to short-circuit than the drive signal wirings 41.

For example, in the present embodiment, the first dummy wiring 44 and the second dummy wiring 45 are disposed outside the plurality of drive signal wirings 41 in the arrangement direction of the plurality of drive signal wirings 41. The end portions of the flexible substrate 4 in the direction along the Y-axis are more likely to be exposed to a high humidity environment than the center portion of the flexible substrate 4 in the direction along the Y-axis. Therefore, it is considered that the first dummy wiring 44 and the second dummy wiring 45 disposed on the outside will short-circuit before the plurality of drive signal wiring 41 disposed in the center portion of the flexible substrate 4 in the direction along the Y-axis. Therefore, in the present embodiment, it is possible to easily detect a short circuit between the first dummy wiring 44 and the second dummy wiring 45 at an early stage. Therefore, in the present embodiment, by detecting a short circuit between the first dummy wiring 44 and the second dummy wiring 45, it is possible to predict the life of the flexible substrate 4 before a short circuit occurs between the drive signal wirings 41, which directly affects the liquid ejection characteristics. That is, in the present embodiment, by detecting a short circuit between the first dummy wiring 44 and the second dummy wiring 45, it is possible to predict the life of the flexible substrate 4 caused by migration before a liquid ejection failure occurs due to migration. As a result, in the present embodiment, it is possible to suppress the occurrence of liquid ejection failures. Furthermore, in the present embodiment, it is possible to prompt a user to replace the liquid ejecting head 200 before a liquid ejection failure occurs. For example, when the control circuit 11 detects a short circuit between the first dummy wiring 44 and the second dummy wiring 45, the control circuit 11 may notify a user of a warning prompting replacement of the liquid ejecting head 200. For example, the notification may be given by a display device (not shown) that is configured by a liquid crystal display, an organic EL display, an LED lamp, or the like and is attached to the housing of the liquid ejecting apparatus 100. Instead of a display device, notification may be given by, for example, a voice generating section that emits an alarm sound or voice, or by blinking or turning on a white light portion such as an LED lamp. Furthermore, a signal may be output to an external device, such as a host computer, that is coupled to the liquid ejecting apparatus 100 to be able to communicate with the outside, to warn a user to prompt replacement of the liquid ejecting head 200.

For example, it is preferable that an interval D1 between the first dummy wiring 44 and the second dummy wiring 45 is narrower than an interval D2 between the adjacent drive signal wirings 41 among the plurality of drive signal wirings 41. Migration is more likely to occur when the interval between wirings is narrow than when the interval between wirings is wide. Therefore, in an aspect in which the interval D1 is narrower than the interval D2, it is possible to intentionally cause a short circuit between the first dummy wiring 44 and the second dummy wiring 45 to occur earlier than a short circuit between the drive signal wirings 41. As a result, in the present aspect, the life of the flexible substrate 4 can be reliably predicted before a liquid ejection failure occurs due to a short circuit between the drive signal wirings 41, compared to when the interval D1 is wider than the interval D2.

Furthermore, for example, it is preferable that the interval D1 between the first dummy wiring 44 and the second dummy wiring 45 is narrower than an interval D3 between the two wirings with the largest potential difference among adjacent wirings excluding the first dummy wiring 44 and the second dummy wiring 45 among the plurality of wirings. In the example shown in FIG. 7, the two wirings with the largest potential difference among the adjacent wirings excluding the first dummy wiring 44 and the second dummy wiring 45 among the plurality of wirings, are the electrical wiring 411 of the high potential VHV and the electrical wiring 411 of the ground potential GND. The two wirings with a large potential difference are wirings where migration is likely to occur. The aspect in which the interval D1 is narrower than the interval D3 is likely to obtain the effect of causing a short circuit between the first dummy wiring 44 and the second dummy wiring 45 to occur earlier than a short circuit between two electrical wirings 411 with a large potential difference. Therefore, in the present aspect, it is possible to easily detect an abnormality in the flexible substrate 4 before a failure that adversely affects the ejection of the liquid occurs.

Note that when adjacent wirings include wirings to which a signal that is not at a constant potential is supplied, the potential difference between the adjacent wirings may be considered as follows. Examples of a wiring to which a signal that is not at a constant potential is supplied include the electrical wiring 411 to which the drive signal COM is supplied and the drive signal wiring 41 to which the drive signal Vout is supplied.

For example, when one of adjacent wirings is a wiring to which a signal that is not at a constant potential is supplied, the difference between the highest potential or the lowest potential of one wiring and the potential of the other wiring may be used as the potential difference between the adjacent wirings. For example, when the highest potential of the drive signal Vout is the high potential VHV and the lowest potential of the drive signal Vout is the ground potential GND, the potential difference between the adjacent drive signal wirings 41 is a potential difference between the high potential VHV and the ground potential GND. In this case, similarly to the electrical wiring 411 of the high potential VHV and the electrical wiring 411 of the ground potential GND, the adjacent drive signal wirings 41 are also two wirings with the largest potential difference among the adjacent wirings. The difference between the average potential per unit time of one wiring and the potential of the other wiring may be used as the potential difference between adjacent wirings.

Also, for example, when both adjacent wirings are wirings to which signals that are not at a constant potential are supplied, the potential difference between the adjacent wirings may be used as the larger of the difference between the highest potential of one wiring and the lowest potential of the other wiring, and the difference between the lowest potential of one wiring and the highest potential of the other wiring. Alternatively, the average value of the potential difference between one wiring and the other wiring per unit time may be used as the potential difference between the adjacent wirings.

In addition, when considering two aspects in which the potential difference is the same, migration is more likely to occur in the aspect in which the potential difference between the adjacent wirings is constant than in the aspect in which adjacent wirings include wirings to which signals with changing potentials are supplied. Therefore, it is preferable that the potential of the first dummy wiring 44 and the potential of the second dummy wiring 45 are held at constant potentials different from each other.

In addition, in FIG. 7, as described above, a case where the potential VD1 is the same as the potential of the reference voltage signal VBS, and the potential VD2 is the same as the high potential VHV is assumed. That is, the potential VD1 of the first dummy wiring 44 and the potential of the constant voltage wiring 42 are held at the same potential, and the potential VD2 of the second dummy wiring 45 and the potential of the electrical wiring 411 of the high potential VHV are held at the same potential. Migration occurs between two wirings that have a potential difference. Therefore, in the present embodiment, it is possible to suppress the occurrence of a short circuit between the first dummy wiring 44 and the constant voltage wiring 42, and a short circuit between the second dummy wiring 45 and the electrical wiring 411 of the high potential VHV. In the present embodiment, by generating a short circuit between the first dummy wiring 44 and the second dummy wiring 45, it is possible to predict the life of the flexible substrate 4 caused by migration while suppressing any adverse effects on the liquid ejection.

In addition, the interval D1 between the first dummy wiring 44 and the second dummy wiring 45 may be narrower than each of an interval D4 between the first dummy wiring 44 and the constant voltage wiring 42 and an interval D5 between the second dummy wiring 45 and the electrical wiring 411 of the high potential VHV. In the present aspect, even when there is a potential difference between the first dummy wiring 44 and the constant voltage wiring 42, it is possible to suppress the occurrence of a short circuit between the first dummy wiring 44 and the constant voltage wiring 42 before a short circuit occurs between the first dummy wiring 44 and the second dummy wiring 45. Similarly, in the present aspect, even when there is a potential difference between the second dummy wiring 45 and the high potential VHV electrical wiring 411, it is possible to suppress the occurrence of a short circuit between the second dummy wiring 45 and the high potential VHV electrical wiring 411 before a short circuit occurs between the first dummy wiring 44 and the second dummy wiring 45. In the present aspect as well, by causing a short circuit between the first dummy wiring 44 and the second dummy wiring 45, it is possible to suppress adverse effects on the ejection of a liquid.

Also, for example, the interval D1 between the first dummy wiring 44 and the second dummy wiring 45 may be set to the narrowest interval among the intervals between adjacent wirings at different potentials. Since migration occurs between two wirings with a potential difference, the present aspect is likely to obtain the effect of causing a short circuit between the first dummy wiring 44 and the second dummy wiring 45 to occur the earliest among the wirings of the flexible substrate 4.

In the present embodiment, each of the first dummy wiring 44 and the second dummy wiring 45 is wired from the first coupling area Ac1 to the second coupling area Ac2. In the present embodiment, the adjacent portions of the first dummy wiring 44 and the second dummy wiring 45 are long, and therefore the area in which short circuits between wirings can be detected increases. Therefore, in the present embodiment, the life of the flexible substrate 4 caused by migration can be accurately predicted. Each of the first dummy wiring 44 and the second dummy wiring 45 may be wired from the first coupling area Ac1 to a portion of the wiring area Aw that is not covered with the cover film 420. Even in this case, since the adjacent portions of the first dummy wiring 44 and the second dummy wiring 45 are long, it is possible to accurately predict the life of the flexible substrate 4 caused by migration.

Furthermore, when focusing on the material of the wiring, the first dummy wiring 44 and the second dummy wiring 45 may contain a metal with a lower ionization energy than the other wirings, that is, a metal with a higher ionization tendency than the other wirings. For example, when the wirings other than the first dummy wiring 44 and the second dummy wiring 45 among the plurality of wirings provided on the flexible substrate 4 mainly contain copper (Cu), the first dummy wiring 44 and the second dummy wiring 45 may contain aluminum (Al) or tin (Sn), which have a higher ionization tendency than copper (Cu). In the present aspect, since the first dummy wiring 44 and the second dummy wiring 45 have a higher ionization tendency than the other wirings, it is possible to intentionally cause a short circuit between the first dummy wiring 44 and the second dummy wiring 45 to occur the earliest among the wirings of the flexible substrate 4.

Furthermore, from the viewpoint of suppressing the increase in size of the flexible substrate 4, it is preferable that the total area of the first dummy wiring 44 and the second dummy wiring 45 is smaller than the area of the constant voltage wiring 42.

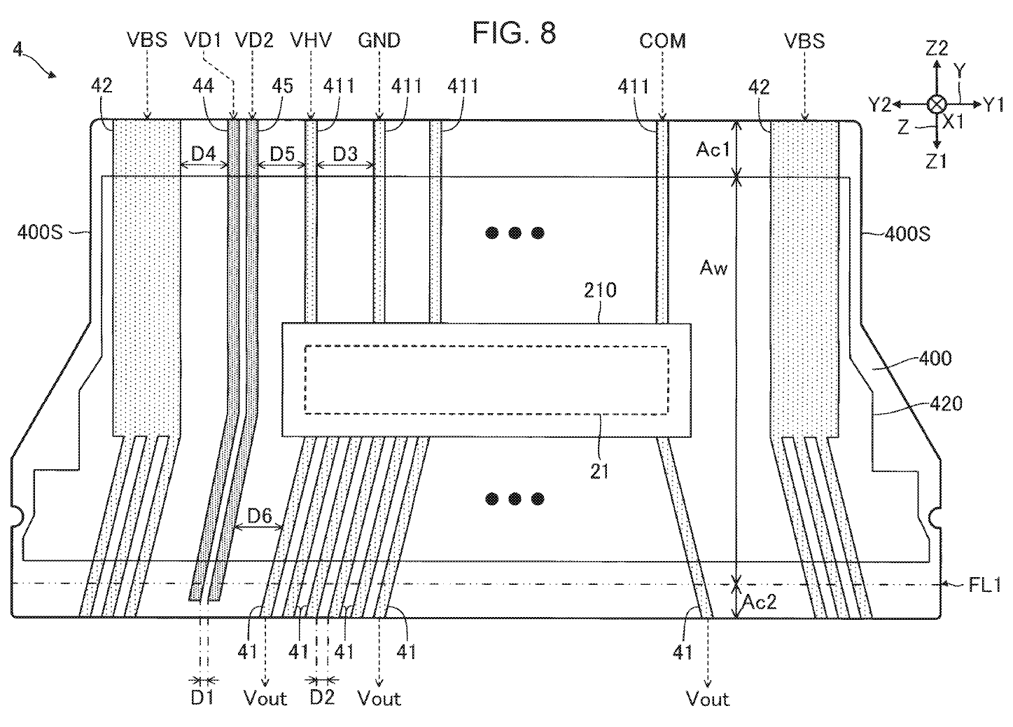

The configuration of the flexible substrate 4 is not limited to the example shown in FIG. 7. For example, as shown in FIG. 8, each of the first dummy wiring 44 and the second dummy wiring 45 may be disposed without reciprocating along the Z-axis.

FIG. 8 is a view showing another example of the flexible substrate 4. The flexible substrate 4 shown in FIG. 8 is similar to the flexible substrate 4 shown in FIG. 7, except that the first dummy wiring 44 and the second dummy wiring 45 are each disposed without reciprocating along the Z-axis.

Each of the first dummy wiring 44 and the second dummy wiring 45 is wired from the first coupling area Ac1 to the second coupling area Ac2 without reciprocating along the Z-axis. Therefore, the end portions of each of the first dummy wiring 44 and the second dummy wiring 45 in the Z2 direction are located in the first coupling area Ac1, and the end portions of each of the first dummy wiring 44 and the second dummy wiring 45 in the Z1 direction are located in the second coupling area Ac2. The end portion of the first dummy wiring 44 in the Z2 direction is coupled to a terminal (not shown) to which the potential VD1 of the wiring substrate 27 is supplied, and the end portion of the first dummy wiring 44 in the Z1 direction is open. Further, the end portion of the second dummy wiring 45 in the Z2 direction is coupled to a terminal (not shown) to which the potential VD2 of the wiring substrate 27 is supplied, and the end portion of the second dummy wiring 45 in the Z1 direction is open. In addition, one or both of the first dummy wiring 44 and the second dummy wiring 45 are electrically coupled to the detection circuit 25.

In the flexible substrate 4 shown in FIG. 8, since the end portions of each of the first dummy wiring 44 and the second dummy wiring 45 in the Z1 direction are open, a space for routing the first dummy wiring 44 and the second dummy wiring 45 of the flexible substrate 4 can easily be secured. As a result, it is possible to suppress an increase in size of the flexible substrate 4.

Also, in the flexible substrate 4 shown in FIG. 8, the first dummy wiring 44 and the second dummy wiring 45 are disposed between the constant voltage wiring 42 located at the end portion of the flexible substrate 4 in the direction along the Y-axis and the central wiring group of the plurality of drive signal wirings 41 and the plurality of electrical wirings 411. Further, the first dummy wiring 44 is disposed between the constant voltage wiring 42 and the second dummy wiring 45, and the second dummy wiring 45 is disposed between the first dummy wiring 44 and the central wiring group.

In the flexible substrate 4 shown in FIG. 8, the preferable conditions for the interval D1 between the first dummy wiring 44 and the second dummy wiring 45 are the same as those in the flexible substrate 4 shown in FIG. 7. In the flexible substrate 4 shown in FIG. 8, since the first dummy wiring 44 and the second dummy wiring 45 are each disposed without reciprocating along the Z-axis, it is possible to suppress an increase in size of the flexible substrate 4.

The configuration of the flexible substrate 4 is not limited to the example shown in FIG. 8. For example, the first dummy wiring 44 and the second dummy wiring 45 may be provided only in the first coupling area Ac1 among the first coupling area Ac1, the wiring area Aw, and the second coupling area Ac2. For example, the first dummy wiring 44 and the second dummy wiring 45 extending along the Z-axis may be provided only in the first coupling area Ac1 among the first coupling area Ac1, the wiring area Aw, and the second coupling area Ac2. In the present aspect, since the first dummy wirings 44 and the second dummy wirings 45 are not provided in the wiring area Aw and the second coupling area Ac2, it is possible to suppress an increase in size of the flexible substrate 4.

Furthermore, one of the first dummy wiring 44 and the second dummy wiring 45 may be disposed to reciprocate along the Z-axis, as shown in FIG. 7. For example, the first dummy wiring 44 may be wired from the first coupling area Ac1 to the second coupling area Ac2 without reciprocating along the Z-axis, and the second dummy wiring 45 may be wired to reciprocate along the Z-axis.

In addition, in FIGS. 7 and 8, it is assumed that the potential VD1 is the same as the potential of the reference voltage signal VBS, but the potential VD1 may be the ground potential GND. That is, the first dummy wiring 44 may be a ground wiring that is held at the ground potential GND. In the present aspect, since the potential difference between the first dummy wiring 44 and the second dummy wiring 45 can be increased, migration can occur more easily between the first dummy wiring 44 and the second dummy wiring 45. For example, when the potential VD1 of the first dummy wiring 44 is the ground potential GND and the potential VD2 of the second dummy wiring 45 is the same potential as the high potential VHV, the first dummy wiring 44 and the second dummy wiring 45 correspond to the two wirings with the largest potential difference among the plurality of wirings that are provided on the flexible substrate 4 and are adjacent to each other. In this case, by making the interval D1 between the first dummy wiring 44 and the second dummy wiring 45 the narrowest among the intervals between adjacent wirings at different potentials, it is possible to cause a short circuit between the first dummy wiring 44 and the second dummy wiring 45 to occur the earliest among the wirings of the flexible substrate 4. Furthermore, the ground wiring has little effect on other wirings. Accordingly, when the first dummy wiring 44 is a ground wiring, a space for routing the first dummy wiring 44 of the flexible substrate 4 can be easily secured.

### 1-6. Summary of First Embodiment

As described above, in the present embodiment, the liquid ejecting head 200 includes the piezoelectric substrate 30 having the plurality of piezoelectric elements E for ejecting the liquid, the wiring substrate 27, and the flexible substrate 4 that has a plurality of wirings provided thereon and electrically couples the piezoelectric substrate 30 and the wiring substrate 27. The plurality of wirings include the plurality of drive signal wirings 41 that are respectively coupled to the plurality of piezoelectric elements E, and the first dummy wiring 44 and the second dummy wiring 45 that are adjacent to each other for detecting deterioration of the flexible substrate 4 caused by migration and are held at different potentials.

In this way, in the present embodiment, the flexible substrate 4 has the first dummy wiring 44 and the second dummy wiring 45 for migration detection that do not directly affect the ejection. Accordingly, in the present embodiment, it is possible to predict the life of the flexible substrate 4 caused by migration before a short circuit occurs due to migration of the wiring, which directly affects the ejection. Examples of short circuits in wiring that directly affect ejection include short circuits between drive signal wirings 41, and short circuits between the drive signal wiring 41 or the constant voltage wiring 42 and other wirings. When a short circuit occurs in the wiring that directly affects the ejection, an ejection failure will occur. That is, in the present embodiment, by detecting a short circuit between the first dummy wiring 44 and the second dummy wiring 45, it is possible to predict the life of the flexible substrate 4 caused by migration before an ejection failure occurs due to migration. As a result, in the present embodiment, it is possible to suppress the occurrence of liquid ejection failures. Furthermore, in the present embodiment, it is possible to prompt a user to replace the liquid ejecting head 200 before a liquid ejection failure occurs.

In the present embodiment, the interval D1 between the first dummy wiring 44 and the second dummy wiring 45 may be narrower than the interval D2 between adjacent drive signal wirings 41 among the plurality of drive signal wirings 41. In an aspect in which the interval D1 is narrower than the interval D2, a short circuit between the first dummy wiring 44 and the second dummy wiring 45 can occur more easily and earlier than a short circuit between the drive signal wirings 41. As a result, in the present aspect, it is possible to increase the likelihood of detecting a short circuit between the first dummy wiring 44 and the second dummy wiring 45 before a liquid ejection failure caused by a short circuit between the drive signal wirings 41 occurs.

Furthermore, in the present embodiment, the interval D1 between the first dummy wiring 44 and the second dummy wiring 45 may be narrower than an interval between the two wirings with the largest potential difference among the adjacent wirings excluding the first dummy wiring 44 and the second dummy wiring 45 among the plurality of wirings. In the flexible substrate 4 shown in FIG. 7 or 8, the two wirings with the largest potential difference among the adjacent wirings correspond to the electrical wiring 411 of the high potential VHV and the electrical wiring 411 of the ground potential GND that are adjacent to each other. In addition, when both adjacent wirings are wirings to which signals that are not at a constant potential are supplied, depending on how the potential difference is perceived, the adjacent drive signal wirings 41 also correspond to the two wirings with the largest potential difference among the adjacent wirings. However, as explained in FIG. 7, when considering two aspects in which the potential difference is the same, migration is more likely to occur in the aspect in which the potential difference between adjacent wirings is constant than in the aspect in which adjacent wirings include wirings to which signals with changing potentials are supplied. Therefore, in the present embodiment, the interval D1 between the first dummy wiring 44 and the second dummy wiring 45 may be narrower than the interval D3 between the electrical wiring 411 of the high potential VHV and the ground potential GND electrical wiring 411, which have the largest potential difference among the adjacent wirings excluding the first dummy wiring 44 and the second dummy wiring 45 among the plurality of wirings. The present aspect is likely to obtain the effect of causing a short circuit between the first dummy wiring 44 and the second dummy wiring 45 to occur earlier than a short circuit between two electrical wirings 411 with a large potential difference. Therefore, in the present aspect, it is possible to easily detect an abnormality in the flexible substrate 4 caused by migration before an ejection failure occurs due to migration.

In the present embodiment, the first dummy wiring 44 and the second dummy wiring 45 may be two wirings with the largest potential difference among the plurality of wirings that are adjacent to each other. In the present aspect, a short circuit between the first dummy wiring 44 and the second dummy wiring 45 can be made most likely to occur the earliest among the wirings of the flexible substrate 4.

In addition, in the present embodiment, the plurality of wirings may include a constant voltage wiring 42 that interposes the first dummy wiring 44 between the constant voltage wiring 42 and the second dummy wiring 45 and is held at the same potential as the first dummy wiring 44, and an electrical wiring 411 of the high potential VHV that interposes the second dummy wiring 45 between the electrical wiring 411 and the first dummy wiring 44 and is held at the same potential as the second dummy wiring 45. In the present aspect, it is possible to suppress the occurrence of a short circuit between the first dummy wiring 44 and the constant voltage wiring 42, and a short circuit between the second dummy wiring 45 and the electrical wiring 411 of the high potential VHV. Therefore, in the present aspect, by generating a short circuit between the first dummy wiring 44 and the second dummy wiring 45, it is possible to predict the life of the flexible substrate 4 caused by migration while suppressing any adverse effects on the liquid ejection.

Furthermore, in the present embodiment, the interval D1 between the first dummy wiring 44 and the second dummy wiring 45 may be narrower than an interval D4 between the first dummy wiring 44 and the constant voltage wiring 42 and an interval D5 between the second dummy wiring 45 and the electrical wiring 411 of the high potential VHV. In the present aspect, even when there is a potential difference between the first dummy wiring 44 and the constant voltage wiring 42, it is possible to suppress the occurrence of a short circuit between the first dummy wiring 44 and the constant voltage wiring 42 before a short circuit occurs between the first dummy wiring 44 and the second dummy wiring 45. Similarly, in the present aspect, even when there is a potential difference between the second dummy wiring 45 and the high potential VHV electrical wiring 411, it is possible to suppress the occurrence of a short circuit between the second dummy wiring 45 and the high potential VHV electrical wiring 411 before a short circuit occurs between the first dummy wiring 44 and the second dummy wiring 45. Therefore, in the present aspect, by generating a short circuit between the first dummy wiring 44 and the second dummy wiring 45, it is possible to predict the life of the flexible substrate 4 caused by migration while suppressing any adverse effects on the liquid ejection.

In addition, in the present embodiment, the plurality of wirings include a constant voltage wiring 42 that is commonly coupled to a plurality of piezoelectric elements E, and the total area of the first dummy wiring 44 and the second dummy wiring 45 may be smaller than the area of the constant voltage wiring 42. In the present aspect, it is possible to suppress an increase in size of the flexible substrate 4.

In the present embodiment, one of the first dummy wiring 44 and the second dummy wiring 45 may be a ground wiring that is held at the ground potential. In the present aspect, since the potential difference between the first dummy wiring 44 and the second dummy wiring 45 can be increased, migration can occur more easily between the first dummy wiring 44 and the second dummy wiring 45.

In addition, in the present embodiment, the first dummy wiring 44 and the second dummy wiring 45 may be disposed outside the plurality of drive signal wirings 41 in the arrangement direction of the plurality of drive signal wirings 41. In the present aspect, the first dummy wiring 44 and the second dummy wiring 45 are disposed outside the plurality of drive signal wirings 41 in the arrangement direction of the plurality of drive signal wirings 41, and are therefore easily exposed to a high humidity environment. Therefore, in the present aspect, it is possible to easily detect a short circuit between the first dummy wiring 44 and the second dummy wiring 45 at an early stage. Therefore, in the present aspect, by detecting a short circuit between the first dummy wiring 44 and the second dummy wiring 45, it is possible to predict the life of the flexible substrate 4 before a short circuit occurs between the drive signal wirings 41, which directly affects the liquid ejection characteristics.

In addition, in the present embodiment, the flexible substrate 4 has a first coupling area Ac1 coupled to the wiring substrate 27 and a second coupling area Ac2 coupled to the piezoelectric substrate 30, and each of the first dummy wiring 44 and the second dummy wiring 45 may be wired from the first coupling area Ac1 to the second coupling area Ac2. In the present aspect, since the adjacent portions of the first dummy wiring 44 and the second dummy wiring 45 can be made longer, the area in which short circuits between wirings can be detected can be increased. As a result, in the present aspect, the life of the flexible substrate 4 caused by migration can be accurately predicted.

In addition, in the present embodiment, the liquid ejecting head 200 may include a detection circuit 25 that outputs a detection signal Vd for detecting a short circuit between the first dummy wiring 44 and the second dummy wiring 45. For example, the wiring substrate 27 may include a detection circuit 25 that outputs a detection signal Vd for detecting a short circuit between the first dummy wiring 44 and the second dummy wiring 45. In the present aspect, a short circuit between the first dummy wiring 44 and the second dummy wiring 45 can be detected based on the detection signal Vd output from the detection circuit 25.

In addition, in the present embodiment, the liquid ejecting apparatus 100 includes the above-described liquid ejecting head 200 and a control circuit 11 that determines a short circuit between the first dummy wiring 44 and the second dummy wiring 45 based on the detection signal. In the present aspect, the liquid ejecting apparatus 100 can detect a short circuit between the first dummy wiring 44 and the second dummy wiring 45, thereby predicting the life of the flexible substrate 4 caused by migration before a liquid ejection failure occurs due to migration.

### 2. Modification Example

Each aspect described above can be variously modified. Specific aspects of modification examples are exemplified below. Two or more aspects selected in any manner from the following examples can be combined with each other as appropriate within a range not inconsistent with each other. In addition, in the modification examples exemplified below, elements having the same effects and functions as those of the embodiment will be given the reference numerals used in the description above, and each detailed description thereof will be omitted as appropriate.

### 2-1. First Modification Example

In the above-described embodiment, an example was given of the case where the first dummy wiring 44 and the second dummy wiring 45 are disposed between the central wiring group of the plurality of drive signal wirings 41 and the plurality of electrical wirings 411 and the constant voltage wiring 42, but the present disclosure is not limited to such an aspect. For example, the first dummy wiring 44 and the second dummy wiring 45 may be interposed between two wirings with the largest potential difference among the adjacent wirings in the wiring disposition excluding the first dummy wiring 44 and the second dummy wiring 45 from the plurality of wirings provided on the flexible substrate 4, and may be disposed adjacent to one and the other of the two wirings, respectively.

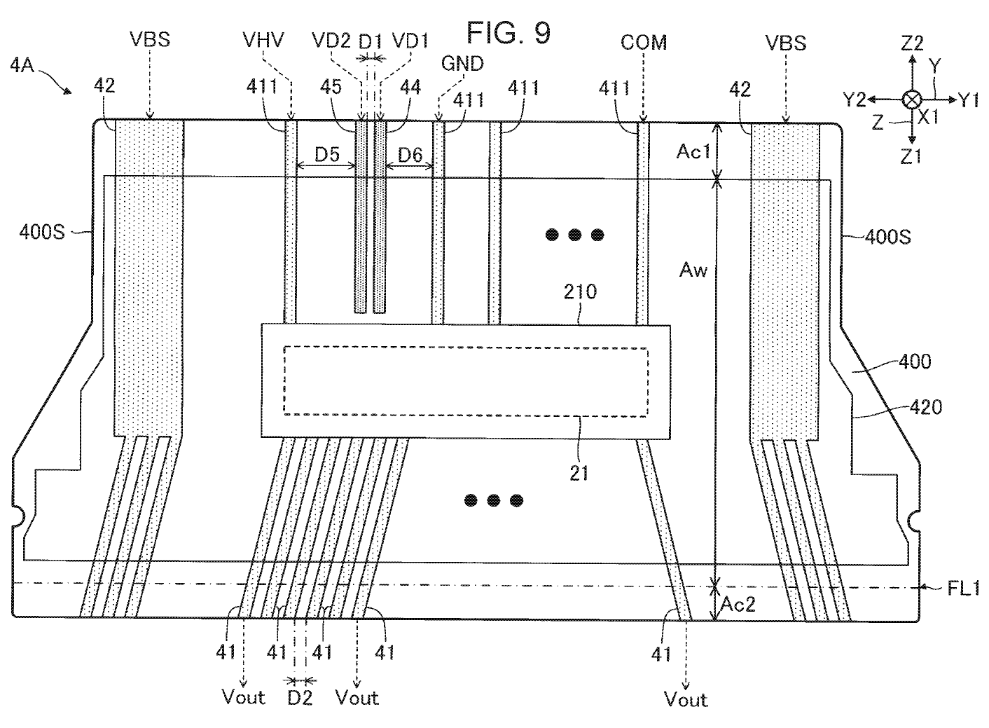

FIG. 9 is a view showing a flexible substrate 4A according to a first modification example. The flexible substrate 4A is similar to the flexible substrate 4 shown in FIG. 8 except for the disposition of the first dummy wiring 44 and the second dummy wiring 45. Moreover, a liquid ejecting module 20 according to the present modification example is similar to the liquid ejecting module 20 according to the embodiment described above, except that a flexible substrate 4A is provided instead of the flexible substrate 4 shown in FIGS. 7 or 8. In FIG. 9, differences between the flexible substrate 4A and the flexible substrate 4 will be mainly described.

In the flexible substrate 4A, the first dummy wiring 44 and the second dummy wiring 45 are disposed to be interposed between two wirings, that is, the electrical wiring 411 of the high potential VHV and the electrical wiring 411 of the ground potential GND. The electrical wiring 411 of the high potential VHV and the electrical wiring 411 of the ground potential GND correspond to the two wirings with the largest potential difference among the adjacent wirings in the wiring disposition excluding the first dummy wiring 44 and the second dummy wiring 45 from the plurality of wirings provided on the flexible substrate 4A. In addition, the first dummy wiring 44 is adjacent to the electrical wiring 411 of the ground potential GND, and the second dummy wiring 45 is adjacent to the electrical wiring 411 of the high potential VHV.

For example, each of the first dummy wiring 44 and the second dummy wiring 45 is wired extending along the Z-axis from the first coupling area Ac1. Note that as described above, the first dummy wiring 44 and the second dummy wiring 45 are disposed between the electrical wiring 411 of the high potential VHV and the electrical wiring 411 of the ground potential GND. Therefore, the end portions of the first dummy wiring 44 and the second dummy wiring 45 in the Z1 direction are located between the first coupling area Ac1 and the mount component 210, for example.

The end portion of the first dummy wiring 44 in the Z2 direction is coupled to a terminal (not shown) to which the potential VD1 of the wiring substrate 27 is supplied, and the end portion of the first dummy wiring 44 in the Z1 direction is open. Further, the end portion of the second dummy wiring 45 in the Z2 direction is coupled to a terminal (not shown) to which the potential VD2 of the wiring substrate 27 is supplied, and the end portion of the second dummy wiring 45 in the Z1 direction is open. In addition, one or both of the first dummy wiring 44 and the second dummy wiring 45 are electrically coupled to the detection circuit 25.

It is preferable that the potential VD1 is the same as the potential of the electrical wiring 411 at the ground potential GND adjacent to the first dummy wiring 44, that is, the ground potential GND. Moreover, it is preferable that the potential VD2 is the same as the potential of the electrical wiring 411 of the high potential VHV adjacent to the second dummy wiring 45, that is, the high potential VHV. That is, it is preferable that the first dummy wiring 44 and the electrical wiring 411 of the ground potential GND that are adjacent to each other are held at the same potential, and the second dummy wiring 45 and the electrical wiring 411 of the high potential VHV that are adjacent to each other are held at the same potential.

In addition, in the flexible substrate 4A, the preferable conditions for the interval D1 between the first dummy wiring 44 and the second dummy wiring 45 are the same as those in the flexible substrate 4 shown in FIG. 7. Furthermore, when the first dummy wiring 44 and the electrical wiring 411 of the ground potential GND that are adjacent to each other are held at different potentials, it is preferable that the interval D1 between the first dummy wiring 44 and the second dummy wiring 45 is narrower than an interval D6 between the first dummy wiring 44 and the electrical wiring 411 of the ground potential GND.

The configuration of the flexible substrate 4A is not limited to the example shown in FIG. 9. For example, the first dummy wiring 44 and the second dummy wiring 45 extending along the Z-axis may be provided only in the first coupling area Ac1 among the first coupling area Ac1, the wiring area Aw, and the second coupling area Ac2. Further, for example, the positions of the electrical wiring 411 of the high potential VHV and the electrical wiring 411 of the ground potential GND may be reversed, and the positions of the first dummy wiring 44 and the second dummy wiring 45 may be reversed.

As described above, in the present modification example, the same effect as that of the embodiment described above can be obtained. Furthermore, in the present modification example, the first dummy wiring 44 and the second dummy wiring 45 are disposed between wirings with a large potential difference, which makes it easy for migration to occur, thereby making it possible to suppress migration from occurring between the wirings with a large potential difference. Accordingly, in the present modification example, it is possible to predict the life of the flexible substrate 4 caused by migration while suppressing adverse effects on the ejection of the liquid.

### 2-2. Second Modification Example

In the above-described embodiment, an example was given of the case where the first dummy wiring 44 and the second dummy wiring 45 are disposed between the central wiring group of the plurality of drive signal wirings 41 and the plurality of electrical wirings 411 and the constant voltage wiring 42, but the present disclosure is not limited to such an aspect. For example, the first dummy wiring 44 and the second dummy wiring 45 may be two wirings disposed at one end in the arrangement direction among a plurality of wirings provided on the flexible substrate 4.

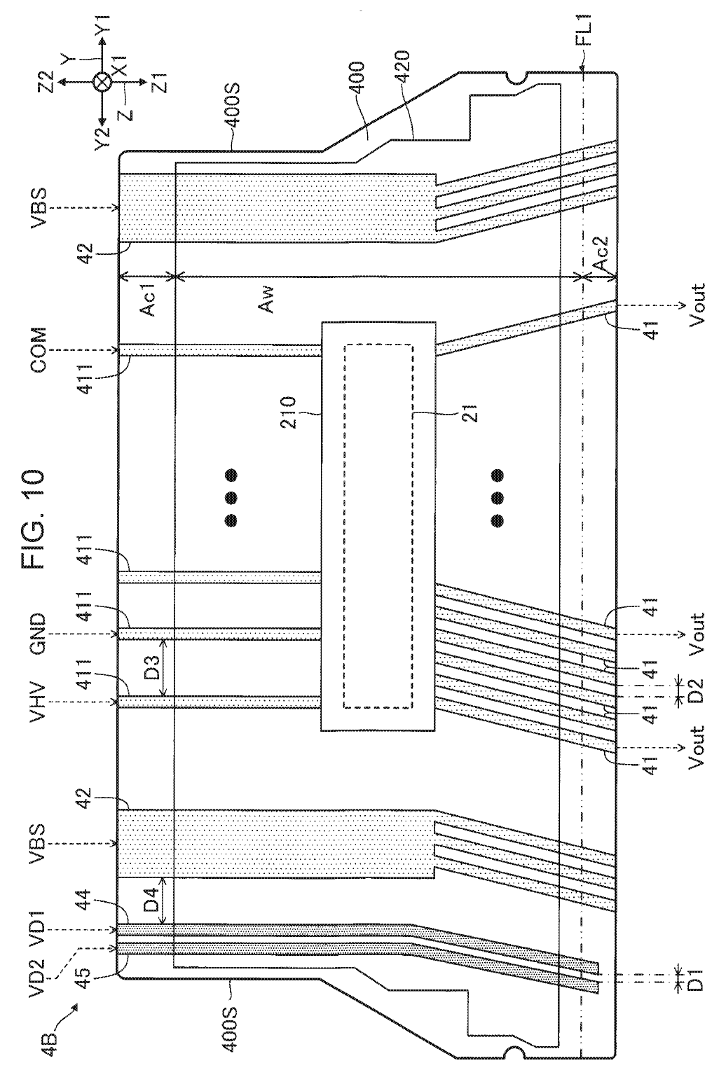

FIG. 10 is a view showing a flexible substrate 4B according to a second modification example. The flexible substrate 4B is similar to the flexible substrate 4 shown in FIG. 8 except for the disposition of the first dummy wiring 44 and the second dummy wiring 45. Moreover, a liquid ejecting module 20 according to the present modification example is similar to the liquid ejecting module 20 according to the embodiment described above, except that a flexible substrate 4B is provided instead of the flexible substrate 4 shown in FIGS. 7 or 8. In FIG. 10, differences between the flexible substrate 4 and the flexible substrate 4B will be mainly described.

In the flexible substrate 4B, the first dummy wiring 44 and the second dummy wiring 45 are two wirings that are disposed at one end in the direction along the Y-axis among the plurality of wirings provided on the flexible substrate 4. In the example shown in FIG. 10, the flexible substrate 4B does not have any other wiring between an end side 400S of the flexible substrate 4 in the Y1 direction and the second dummy wiring 45 in the direction along the Y-axis. That is, the first dummy wiring 44 and the second dummy wiring 45 are provided on the outermost side of the flexible substrate 4 in the Y-axis.

The potential VD1 may be the same as the potential of the constant voltage wiring 42 adjacent to the first dummy wiring 44, that is, the potential of the reference voltage signal VBS. Alternatively, the potential VD1 may be the same as the ground potential GND. In addition, in the flexible substrate 4B, the preferable conditions for the interval D1 between the first dummy wiring 44 and the second dummy wiring 45 are the same as those in the flexible substrate 4 shown in FIG. 7.

The configuration of the flexible substrate 4B is not limited to the example shown in FIG. 10. For example, the first dummy wiring 44 and the second dummy wiring 45 extending along the Z-axis may be provided only in the first coupling area Ac1 among the first coupling area Ac1, the wiring area Aw, and the second coupling area Ac2.

As described above, in the present modification example, the same effect as that of the embodiment described above can be obtained. Furthermore, in the present modification example, the first dummy wiring 44 and the second dummy wiring 45 are disposed at the end portion of the flexible substrate 4B in the direction along the Y-axis, and therefore are easily exposed to a high humidity environment. Therefore, in the present modification example, it is possible to easily detect a short circuit between the first dummy wiring 44 and the second dummy wiring 45 at an early stage.

### 2-3. Third Modification Example

In the above-described embodiment, an example was given of the case where the detection circuit 25 is mounted on the wiring substrate 27, but the present disclosure is not limited to such an aspect. For example, the mount component 210 including the drive signal selection circuit 21 may include a detection circuit 25 that outputs a detection signal Vd for detecting a short circuit between the first dummy wiring 44 and the second dummy wiring 45.

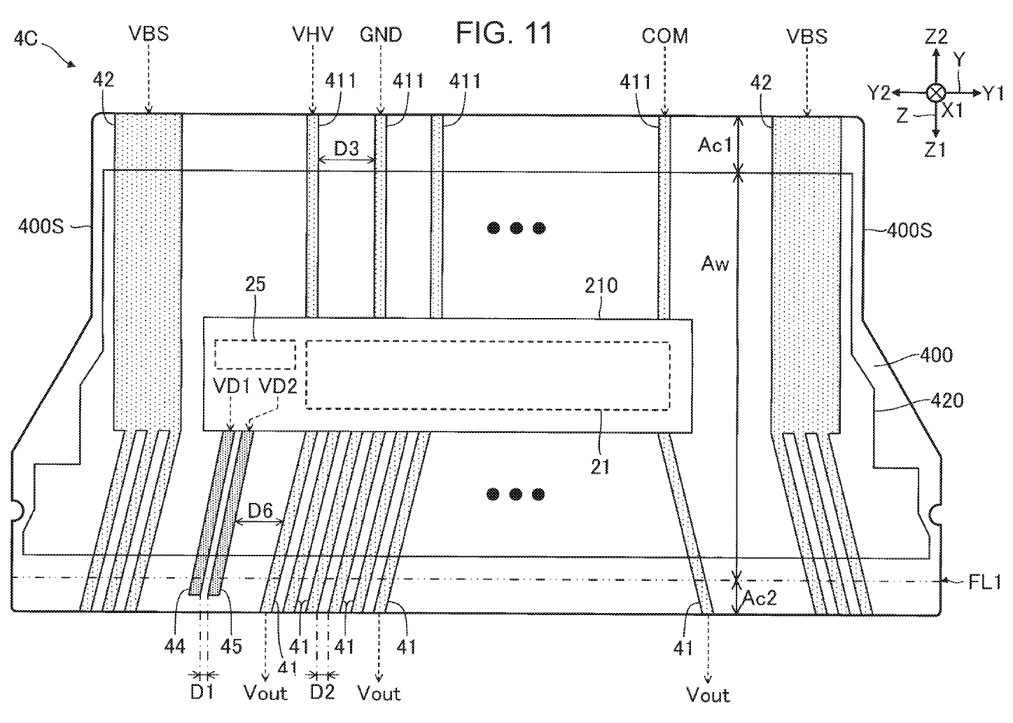

FIG. 11 is a view showing a flexible substrate 4C according to a third modification example. The flexible substrate 4C is similar to the flexible substrate 4 shown in FIG. 8 except for the disposition of the first dummy wiring 44 and the second dummy wiring 45 and the fact that the mount component 210 includes the detection circuit 25. Moreover, a liquid ejecting module 20 according to the present modification example is similar to the liquid ejecting module 20 according to the embodiment described above, except that a flexible substrate 4C is provided instead of the flexible substrate 4 shown in FIGS. 7 or 8. In FIG. 11, differences between the flexible substrate 4 and the flexible substrate 4C will be mainly described.

In the present modification example, for example, the detection circuit 25 shown in FIG. 2 is omitted from the wiring substrate 27 and is included in the mount component 210. The first dummy wiring 44 and the second dummy wiring 45 are wired from the mount component 210 including the detection circuit 25 to the second coupling area Ac2. The first dummy wiring 44 and the second dummy wiring 45 are two wirings disposed at one end in the direction along the Y-axis among the plurality of wirings wired from the mount component 210 to the second coupling area Ac2. That is, the first dummy wiring 44 and the second dummy wiring 45 are disposed outside the plurality of drive signal wirings 41.

The end portion of the first dummy wiring 44 in the Z2 direction is coupled to a terminal (not shown) to which the potential VD1 of the mount component 210 is supplied, and the end portion of the first dummy wiring 44 in the Z1 direction is open. Further, the end portion of the second dummy wiring 45 in the Z2 direction is coupled to a terminal (not shown) to which the potential VD2 of the mount component 210 is supplied, and the end portion of the second dummy wiring 45 in the Z1 direction is open. In addition, one or both of the first dummy wiring 44 and the second dummy wiring 45 are electrically coupled to the detection circuit 25 included in the mount component 210.

In addition, in the flexible substrate 4C, the preferable conditions for the interval D1 between the first dummy wiring 44 and the second dummy wiring 45 are the same as those in the flexible substrate 4 shown in FIG. 7. For example, the interval D1 between the first dummy wiring 44 and the second dummy wiring 45 is narrower than an interval D2 between adjacent drive signal wirings 41 among the plurality of drive signal wirings 41.

The configuration of the flexible substrate 4C is not limited to the example shown in FIG. 11. For example, each of the first dummy wiring 44 and the second dummy wiring 45 may be wired from the mount component 210 to a portion of the wiring area Aw that is not covered with the cover film 420.

As described above, in the present modification example, the same effect as that of the embodiment described above can be obtained. Furthermore, in the present modification example, since the detection circuit 25 is included in the mount component 210, it is possible to easily ensure a space for disposing the first dummy wiring 44 and the second dummy wiring 45.

### 2-4. Fourth Modification Example

In the above-described embodiment and modification examples, an example was given of the case where the liquid ejecting head 200 has the detection circuit 25, but the present disclosure is not limited to such an aspect. For example, the liquid ejecting apparatus 100 may have a liquid ejecting head 200 from which the detection circuit 25 is omitted, and a detection circuit 25 provided outside the liquid ejecting head 200. Specifically, the detection circuit 25 may be included in the control unit 10, for example. In the present modification example, the same effects as those of the embodiment and the modification examples described above can be obtained.

### 2-5. Fifth Modification Example

In the above-described embodiment and modification examples, three or more dummy wirings including a first dummy wiring 44 and a second dummy wiring 45 may be provided in order to predict in stages the life of the flexible substrate 4 caused by migration. For example, in the three or more dummy wirings, the intervals between adjacent wirings may be made different. Furthermore, for example, in the three or more dummy wirings, the potential difference between adjacent wirings may be made different. Furthermore, the three or more dummy wirings may be made of different materials. As described above, in the present modification example, the same effects as those of the embodiment and the modification example described above can be obtained. Furthermore, in the present modification example, the life of the flexible substrate 4 caused by migration can be predicted in stages.

### 2-6. Sixth Modification Example

In the above-described embodiment and modification examples, the control circuit 11 may predict in stages the life of the flexible substrate 4 caused by migration based on the detection signal Vd indicating a change in the current flowing through the first dummy wiring 44 or the second dummy wiring 45, or a change in the voltage of the first dummy wiring 44 or the second dummy wiring 45. For example, the resistance between the first dummy wiring 44 and the second dummy wiring 45 due to the short circuit between the first dummy wiring 44 and the second dummy wiring 45 changes depending on the degree of migration of the first dummy wiring 44 and the second dummy wiring 45. Therefore, in the present modification example, the degree of migration can be predicted in stages based on changes in the current flowing through the first dummy wiring 44 or the second dummy wiring 45, or the like. As described above, in the present modification example, the same effects as those of the embodiment and the modification example described above can be obtained. Furthermore, in the present modification example, the life of the flexible substrate 4 caused by migration can be predicted in stages.

### 2-7. Seventh Modification Example

In the above-described embodiment, the potential of the reference voltage signal VBS supplied to the plurality of constant voltage wirings 42 electrically coupled to the common electrode 52 of the piezoelectric element E may be the ground potential GND. In the present modification example, the same effects as those of the embodiment and the modification examples described above can be obtained.

### 2-8. Eighth Modification Example

In the above-described embodiment and modification examples, an example was given of the case where the liquid ejecting head 200 has six liquid ejecting modules 20, but the present disclosure is not limited to such an aspect. For example, the liquid ejecting head 200 may have one or more and five or less liquid ejecting modules 20, or seven or more liquid ejecting modules 20. In the present modification example, the same effect as that of the embodiment described above can be obtained.

### 2-9. Ninth Modification Example

The liquid ejecting apparatus 100 exemplified in the above-described embodiment and modification examples can be employed in various devices such as facsimile machines and copiers, in addition to devices dedicated to printing. However, the application of the liquid ejecting apparatus according to the present disclosure is not limited to printing. For example, a liquid ejecting apparatus that ejects a solution of a coloring material is used as a manufacturing apparatus that forms a color filter of a display device such as a liquid crystal display panel. Furthermore, a liquid ejecting apparatus that ejects a solution of a conductive material is used as a manufacturing apparatus that forms wiring or an electrode of a wiring substrate. In addition, a liquid ejecting apparatus that ejects a solution of an organic material related to a living body is used as, for example, a manufacturing apparatus that manufactures a biochip. In the present modification example, the same effects as those of the embodiment and the modification examples described above can be obtained.

### 3. Supplementary Notes

From the embodiments described above, for example, the following configuration can be ascertained.

A liquid ejecting head according to a first aspect, which is a preferred aspect, includes: an actuator substrate having a plurality of drive elements for ejecting a liquid; a wiring substrate; and a flexible substrate provided with a plurality of wirings and electrically coupling the actuator substrate and the wiring substrate, in which the plurality of wirings include a plurality of individual signal wirings respectively coupled to the plurality of drive elements, and a first wiring and a second wiring that are adjacent to each other for detecting deterioration of the flexible substrate caused by migration and are held at different potentials. According to the first aspect, it is possible to predict the life of a flexible substrate caused by migration before an ejection failure occurs due to migration.

In the liquid ejecting head according to a second aspect, which is a specific example of the first aspect, an interval between the first wiring and the second wiring is narrower than an interval between adjacent individual signal wirings among the plurality of individual signal wirings. According to the second aspect, it is possible to increase the likelihood of detecting a short circuit between the first wiring and the second wiring before a liquid ejection failure caused by a short circuit between the individual signal wirings occurs.

In the liquid ejecting head according to a third aspect, which is a specific example of the first or second aspect, an interval between the first wiring and the second wiring is narrower than an interval between two adjacent wirings with a largest potential difference among adjacent wirings excluding the first wiring and the second wiring among the plurality of wirings. According to the third aspect, it is possible to easily detect an abnormality in the flexible substrate 4 caused by migration before an ejection failure occurs due to migration.

In the liquid ejecting head according to a fourth aspect, which is a specific example of the first to third aspects, the first wiring and the second wiring are two wirings with a largest potential difference among the plurality of wirings that are adjacent to each other. According to the fourth aspect, a short circuit between the first wiring and the second wiring can be made most likely to occur the earliest among the wirings of the flexible substrate.

In the liquid ejecting head according to a fifth aspect, which is a specific example of any one of the first to fourth aspects, the first wiring and the second wiring are interposed between two wirings with a largest potential difference among adjacent wirings in a wiring disposition excluding the first wiring and the second wiring from the plurality of wirings, and are adjacent to one and another of the two wirings, respectively. According to the fifth aspect, it is possible to predict the life of the flexible substrate caused by migration while suppressing adverse effects on the ejection of the liquid.

In the liquid ejecting head according to a sixth aspect, which is a specific example of any one of the first to fifth aspects, the plurality of wirings include a third wiring that interposes the first wiring between the third wiring and the second wiring and is held at the same potential as the first wiring, and a fourth wiring that interposes the second wiring between the fourth wiring and the first wiring and is held at the same potential as the second wiring. According to the sixth aspect, it is possible to suppress the occurrence of a short circuit between the first wiring and the third wiring, and a short circuit between the second wiring and the fourth wiring.

In the liquid ejecting head according to a seventh aspect, which is a specific example of any one of the first to sixth aspects, the plurality of wirings include a third wiring that interposes the first wiring between the third wiring and the second wiring, and a fourth wiring that interposes the second wiring between the fourth wiring and the first wiring, and an interval between the first wiring and the second wiring is narrower than each of an interval between the first wiring and the third wiring and an interval between the second wiring and the fourth wiring. According to the seventh aspect, it is possible to suppress the occurrence of a short circuit between the first wiring and the third wiring, and a short circuit between the second wiring and the fourth wiring.

In the liquid ejecting head according to an eighth aspect, which is a specific example of any one of the first to seventh aspects, the plurality of wirings include a common signal wiring that is commonly coupled to the plurality of drive elements, and a total area of the first wiring and the second wiring is smaller than an area of the common signal wiring. According to the eighth aspect, it is possible to suppress an increase in size of the flexible substrate.

In the liquid ejecting head according to a ninth aspect, which is a specific example of any one of the first to eighth aspects, one of the first wiring and the second wiring is a ground wiring that is held at a ground potential. According to the ninth aspect, migration can be made more likely to occur between the first wiring and the second wiring.

In the liquid ejecting head according to a tenth aspect, which is a specific example of any one of the first to ninth aspects, the first wiring and the second wiring are disposed outside the plurality of individual signal wirings in an arrangement direction of the plurality of individual signal wirings. According to the tenth aspect, it is possible to easily detect a short circuit between the first wiring and the second wiring at an early stage.

In the liquid ejecting head according to an eleventh aspect, which is a specific example of any one of the first to fifth aspects, the first wiring and the second wiring are two wirings disposed at one end of the plurality of wirings in the arrangement direction. According to the eleventh aspect, it is possible to easily detect a short circuit between the first wiring and the second wiring at an early stage.

In the liquid ejecting head according to a twelfth aspect, which is a specific example of any one of the first to eleventh aspects, the flexible substrate has a first coupling area coupled to the wiring substrate and a second coupling area coupled to the actuator substrate, and each of the first wiring and the second wiring is wired from the first coupling area to the second coupling area. According to the twelfth aspect, since the adjacent portions of the first wiring and the second wiring can be made longer, the area in which short circuits between wirings can be detected can be increased. As a result, in the present aspect, it is possible to accurately predict the life of the flexible substrate caused by migration.

In the liquid ejecting head according to a thirteenth aspect, which is a specific example of any one of the first to twelfth aspects, the wiring substrate includes a detection circuit that outputs a detection signal for detecting a short circuit between the first wiring and the second wiring. According to the thirteenth aspect, it is possible to detect a short circuit between the first wiring and the second wiring based on the detection signal output from the detection circuit.

In the liquid ejecting head according to a fourteenth aspect, which is a specific example of any one of the first to twelfth aspects, the flexible substrate has a drive component including a selection circuit that selects whether to supply a drive signal to each of the plurality of drive elements, and a second coupling area coupled to the actuator substrate, the plurality of individual signal wirings, the first wiring, and the second wiring are wired from the drive component to the second coupling area, an interval between the first wiring and the second wiring is narrower than an interval between adjacent individual signal wirings among the plurality of individual signal wirings, and the drive component includes a detection circuit that outputs a detection signal for detecting a short circuit between the first wiring and the second wiring. According to the fourteenth aspect, it is possible to easily ensure a space in which the first wiring and the second wiring are disposed.

A liquid ejecting head according to a fifteenth aspect, which is a specific example of any one of the first to twelfth aspects, further includes a detection circuit that outputs a detection signal for detecting a short circuit between the first wiring and the second wiring. According to the fifteenth aspect, it is possible to detect a short circuit between the first wiring and the second wiring based on the detection signal output from the detection circuit.

A liquid ejecting apparatus according to a sixteenth aspect, which is a preferred aspect, includes: the liquid ejecting head according to the fifteenth aspect; and a determination circuit that determines a short circuit between the first wiring and the second wiring based on the detection signal. According to the sixteenth aspect, it is possible to obtain the same effect as that described in any one of the first to twelfth aspects and the fifteenth aspect.

A liquid ejecting apparatus according to a seventeenth aspect, which is a preferred aspect, includes: the liquid ejecting head according to any one of the first to twelfth aspects; and a detection circuit that outputs a detection signal for detecting a short circuit between the first wiring and the second wiring. According to the seventeenth aspect, it is possible to obtain the same effects as those of the first to twelfth aspects and the fifteenth aspect.

What is claimed is:

1. A liquid ejecting head comprising:
an actuator substrate having a plurality of drive elements for ejecting a liquid;
a wiring substrate; and
a flexible substrate provided with a plurality of wirings and electrically coupling the actuator substrate and the wiring substrate, wherein
the plurality of wirings include
a plurality of individual signal wirings respectively coupled to the plurality of drive elements, and
a first wiring and a second wiring that are adjacent to each other for detecting deterioration of the flexible substrate caused by migration and are held at different potentials.

2. The liquid ejecting head according to claim 1, wherein
an interval between the first wiring and the second wiring is narrower than an interval between adjacent individual signal wirings among the plurality of individual signal wirings.

3. The liquid ejecting head according to claim 1, wherein
an interval between the first wiring and the second wiring is narrower than an interval between two adjacent wirings with a largest potential difference among adjacent wirings excluding the first wiring and the second wiring among the plurality of wirings.

4. The liquid ejecting head according to claim 1, wherein
the first wiring and the second wiring are two wirings with a largest potential difference among the plurality of wirings that are adjacent to each other.

5. The liquid ejecting head according to claim 1, wherein
the first wiring and the second wiring are interposed between two wirings with a largest potential difference among adjacent wirings in a wiring disposition excluding the first wiring and the second wiring from the plurality of wirings, and are adjacent to one and another of the two wirings, respectively.

6. The liquid ejecting head according to claim 1, wherein
the plurality of wirings include
a third wiring that interposes the first wiring between the third wiring and the second wiring and is held at the same potential as the first wiring, and
a fourth wiring that interposes the second wiring between the fourth wiring and the first wiring and is held at the same potential as the second wiring.

7. The liquid ejecting head according to claim 1, wherein
the plurality of wirings include
a third wiring that interposes the first wiring between the third wiring and the second wiring, and
a fourth wiring that interposes the second wiring between the fourth wiring and the first wiring, and
an interval between the first wiring and the second wiring is narrower than each of an interval between the first wiring and the third wiring and an interval between the second wiring and the fourth wiring.

8. The liquid ejecting head according to claim 1, wherein
the plurality of wirings include a common signal wiring that is commonly coupled to the plurality of drive elements, and
a total area of the first wiring and the second wiring is smaller than an area of the common signal wiring.

9. The liquid ejecting head according to claim 1, wherein
one of the first wiring and the second wiring is a ground wiring that is held at a ground potential.

10. The liquid ejecting head according to claim 1, wherein
the first wiring and the second wiring are disposed outside the plurality of individual signal wirings in an arrangement direction of the plurality of individual signal wirings.

11. The liquid ejecting head according to claim 10, wherein
the first wiring and the second wiring are two wirings disposed at one end of the plurality of wirings in the arrangement direction.

12. The liquid ejecting head according to claim 1, wherein
the flexible substrate has a first coupling area coupled to the wiring substrate and a second coupling area coupled to the actuator substrate, and
each of the first wiring and the second wiring is wired from the first coupling area to the second coupling area.

13. The liquid ejecting head according to claim 1, wherein
the wiring substrate includes a detection circuit that outputs a detection signal for detecting a short circuit between the first wiring and the second wiring.

14. The liquid ejecting head according to claim 1, wherein
the flexible substrate has a drive component including a selection circuit that selects whether to supply a drive signal to each of the plurality of drive elements, and a second coupling area coupled to the actuator substrate,
the plurality of individual signal wirings, the first wiring, and the second wiring are wired from the drive component to the second coupling area,
an interval between the first wiring and the second wiring is narrower than an interval between adjacent individual signal wirings among the plurality of individual signal wirings, and
the drive component includes a detection circuit that outputs a detection signal for detecting a short circuit between the first wiring and the second wiring.

15. The liquid ejecting head according to claim 1, further comprising:
a detection circuit that outputs a detection signal for detecting a short circuit between the first wiring and the second wiring.

16. A liquid ejecting apparatus comprising:
the liquid ejecting head according to claim 15; and
a determination circuit that determines a short circuit between the first wiring and the second wiring based on the detection signal.

17. A liquid ejecting apparatus comprising:
the liquid ejecting head according to claim 1; and
a detection circuit that outputs a detection signal for detecting a short circuit between the first wiring and the second wiring.
